(19) United States
(12) Patent Application Publication
(10) Pub. No.: US 2026/0199823 A1
(43) Pub. Date: Jul. 16, 2026

(54) IONIC LIQUID-BASED COMPOSITE MEMBRANES USING FUNCTIONAL CROSS-LINKERS

(71) Applicant: The Regents of the University of Colorado, a Body Corporate, Denver, CO (US)

(72) Inventors: Richard D. Noble, Boulder, CO (US); Chamaal Karunaweera, Boulder, CO (US); Douglas L. Gin, Longmont, CO (US)

(21) Appl. No.: 18/686,115

(22) PCT Filed: Aug. 26, 2022
(86) PCT No.: PCT/US2022/041698

§ 371 Date: Feb. 23, 2024

Related U.S. Application Data
(60) Provisional application No. 63/237,694, filed on Aug. 27, 2021.
(60) Provisional application No. 63/278,384, filed on Nov. 11, 2021.

(51) Int. Cl. B01D 53/22; B01D 69/02; B01D 69/12; B01D 71/28; C08F 212/14; C08F 232/08; C08K 5/3445

(52) U.S. Cl. CPC B01D 53/228; B01D 69/02; B01D 69/1216; B01D 69/125; B01D 71/28; C08F 212/26; C08F 232/08; C08K 5/3445; B01D 2256/10; B01D 2256/245; B01D 2257/504; B01D 2325/04; B01D 2325/20; C08F 2810/20

(57) ABSTRACT

The disclosure concerns polymers and membranes composed at least in part of poly(ionic liquids) and non-polymerized ionic liquids, where the polymers and membranes are cross-linked with an IL multifunctional cross-linking agent. The membranes can be used to selectively separate gases such as, but not limited to, CO₂.

### CROSS-REFERENCE TO RELATED APPLICATIONS

This application claims priority to U.S. Provisional Patent Application Ser. No. 63/237,694 entitled “Ionic Liquid-based Composite Membranes Using Functional Crosslinkers,” filed Aug. 27, 2021, and to U.S. Provisional Patent Application Ser. No. 63/278,384 entitled “Ionic Liquid-based Composite Membranes Using Functional Crosslinkers,” filed Nov. 11, 2021, the disclosures of which are incorporated herein by reference in their entireties.

### BACKGROUND

The global demand for natural gas is growing, as is the demand for technologies that can improve extracted gas to pipeline grade. In 2015, the U.S. alone consumed over 24 million standard cubic feet of natural gas, and global natural gas production that year increased by 2.2% from 2014. The removal of CO₂ from these extracted gas streams is paramount since the presence of CO₂ depresses the heating value of natural gas and, in combination with water vapor, generates carbonic acid that corrodes pipeline equipment. Currently, membrane separation systems account for ca. 5% of the natural gas separations market, with amine scrubbing and cryogenic distillation as the dominant approaches. However, the energy costs associated with amine stripping and cryogenics are significant, and amine scrubbing carries an environmental risk. Membrane systems require less operator supervision and capital investment than the dominant technologies.

If CO₂ permeability can be increased without sacrificing membrane selectivity, fewer and smaller membrane modules can be used to process the same volume of gas. Mixed-matrix membranes (MMMs) are membranes composed of a dispersed phase combined with a polymer matrix. MMMs maintain the superior separatory efficiency of the dispersed phase while taking advantage of the relative ease of processing associated with the polymer matrix. The dispersant phase is often a porous, highly selective material that would otherwise be too difficult to efficiently manufacture into a membrane (e.g., zeolites, metal-organic frameworks, or supramolecular organic frameworks). A key disadvantage of these microporous materials is that improper adhesion at the dispersant/matrix interface degrades membrane performance. Interfacial voids, chain rigidification, and pore plugging can all contribute to reduced MMM performance.

There is thus a need in the art for novel materials and methods for performing gas-gas separation. The present invention addresses this need.

### BRIEF SUMMARY OF THE INVENTION

In various aspects, provided herein are a polymerized ionic liquid (PIL) having the formula:

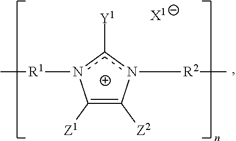

ii) a non-polymerized ionic liquid (IL) having the formula:

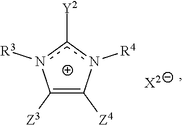

and
iii) an IL cross-linking agent having a formula selected from the group consisting of:

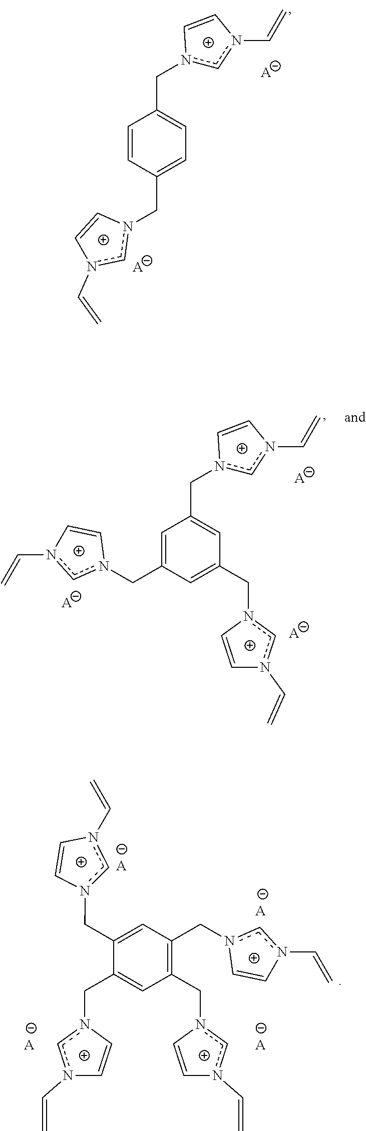

In another aspect, membranes containing the PIL, IL, and IL cross-linking agents described herein are also provided.

In another aspect, polymers of Formula Z and Formula ZZ are provided:

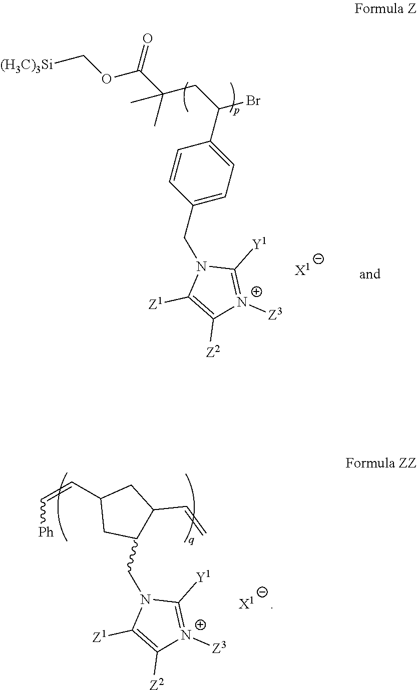

The materials described herein are, in certain aspects, useful in separating gas components from each other. For example, in a non-limiting aspect, the materials described herein are suitable for use in methods of separating a first gas component from a gas mixture containing at least a first gas component and a second gas component. In non-limiting aspects, the first gas component is CO₂ and the second gas component is CH₄ or N₂.

### BRIEF DESCRIPTION OF THE FIGURES

The drawings illustrate generally, by way of example, but not by way of limitation, various embodiments of the present application.

FIGS. 1A-1D is shows [VMIM][Tf₂N]:[EMIM][Tf₂N] (80:20) membrane performance as a function of [TRISVIM][Tf₂N] amount. Membranes were tested using a 50:50 mixture of CO₂:CH₄.

FIG. 2 shows data summarizing [VMIM][Tf₂N]:[EMIM][Tf₂N] (80:20)/11 wt. % [TETRAVIM][Tf₂N] membrane performance. Membranes were tested using a 50:50 mixture of CO₂:CH₄. Values in parentheses indicate permeability and selectivity of [VMIM][Tf₂N]/[EMIM][Tf₂N] (80/20)/11 wt % [TRISVIM][Tf₂N].

FIG. 3 shows [VMIM][Tf₂N]:[EMIM][Tf₂N] membrane performance as a function of [VMIM][Tf₂N]:[EMIM][Tf₂N] ratio. Membranes were tested using a 50:50 mixture of CO₂:CH₄ at 20° C.

FIG. 4 shows [VMIM][Tf₂N]:[EMIM][Tf₂N] membrane performance as a function of [VMIM][Tf₂N]:[EMIM][Tf₂N] ratio. Membranes were tested using a 50:50 mixture of CO₂:CH₄ at 50° C.

FIG. 5 illustrates that [VMIM][Tf₂N]:[EMIM][Tf₂N] (70:30)-8 wt. % [TRISVIM][Tf₂N] exceeds the permeability of the MMM (mixed matrix membranes) and matches selectivity of the MMM, especially at high temperature (last two rows in the table). Values in parentheses are for [VMIM][Tf₂N]:[EMIM][Tf₂N]:SAPO-34 (64:16:20) PIL-IL-zeolite MMM. PIL=poly(ionic liquid); IL=ionic liquid.

FIG. 6 shows CO₂ permeability and CO₂/CH₄ selectivity as a function of time for the disclosed cross-linked PIL/IL membranes compared to conventional membranes composed of 6FDA-DAM:DABA.

FIG. 7 shows CO₂ permeability and CO₂/CH₄ selectivity as a function of time for the disclosed cross-linked PIL/IL membranes compared to conventional cross-linked hollowfiber polyimide membranes.

FIG. 8 shows CO₂ permeability and CO₂/CH₄ selectivity as a function of time for the disclosed cross-linked PIL/IL membranes compared to conventional Matrimid membranes and thin and thick membranes composed of 6FDA-DAM:DABA.

FIG. 9 shows a scheme for synthesizing the PIL-IL-cross-linked membranes described herein, according to various embodiments.

FIG. 10 shows the enthalpy or volume vs. temperature (T) dependence for polymers upon cooling.

FIGS. 11A-11D show (FIG. 11A) Chemical structure of poly([VMIM][Tf₂N]); (FIG. 11B) Chemical structure of [EMIM][Tf₂N]; (FIG. 11C) DSC (differential scanning calorimetry) curves of cross-linked 70 wt. % poly([VMIM][Tf₂N])+30 wt. % [EMIM][Tf₂N]; and (FIG. 11D) derivative DSC curves.

FIG. 12 shows the ratio of CO₂ permeance to initial permeance for an asymmetric CA membrane as a function of time for continuous separation from natural gas (Merrick et al., 2020 from Ma and Koros, 2018).

FIG. 13 shows the effect of aging time on the oxygen permeability for glassy polyacrylate films (made from bisphenol-A benzophenone dicarboxylic acid) with the following thicknesses: (∘) 33, (▪) 28, (⋄) 9.7, (▴) 4.4, (∇) 1.85, (●) 0.99, (□) 0.74, (♦) 0.58, (Δ) 0.25 μm.

FIGS. 14A-14C show the O₂ permeability vs time (log scale) for three polymer membranes. Reproduced from Huang and Paul, 2004.

FIG. 15 shows a non-limiting example of a permeation test apparatus for determining the performance of IL-based polymer blend membranes at high temperature and high feed pressure.

FIGS. 16A-16B show CO₂/CH₄ gas separation performance data for a 70 wt. % poly([VMIM][Tf₂N])+30 wt. % [EMIM][Tf₂N] membrane tested for 10 weeks at 50° C. and 40 bar feed pressure with a 50:50 vol % mixture of CO₂ and CH₄ vs. CO₂/CH₄ gas long-term separation performance data for three glassy uncharged polymer membranes from the literature.

FIG. 16A shows relative permeability data and FIG. 16B shows relative CO₂/CH₄ separation selectivity data.

FIG. 17 shows structures of the charged PIL-based matrix polymer and the two charged, controlled-length IL oligomer platforms to be used in blending and aging studies.

FIGS. 18A-18B show a non-limiting example of a proposed syntheses of two charged, controlled-length IL oligomer additives: (FIG. 18A) synthesis of IL oligomer A using ATRP; and (FIG. 18B) synthesis of IL oligomer B using ROMP.

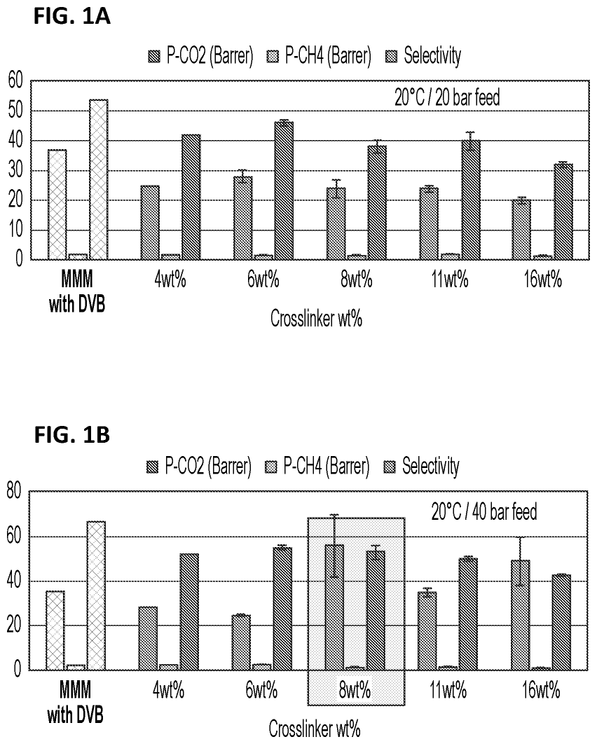

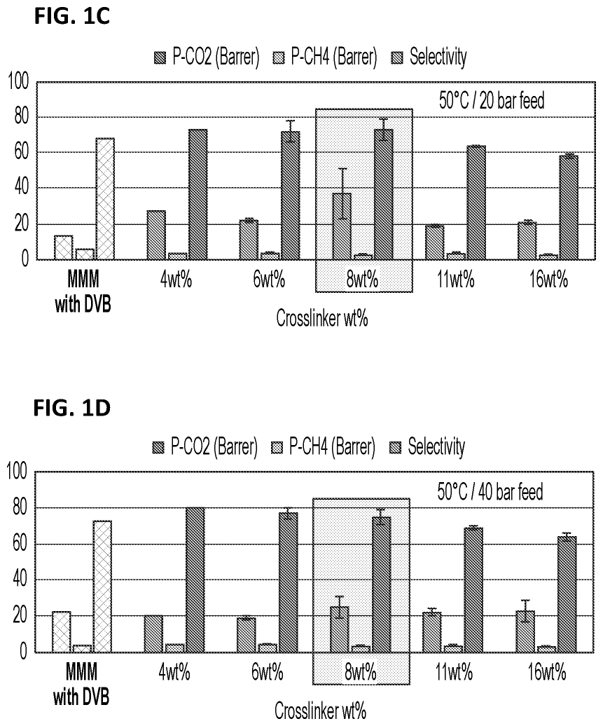

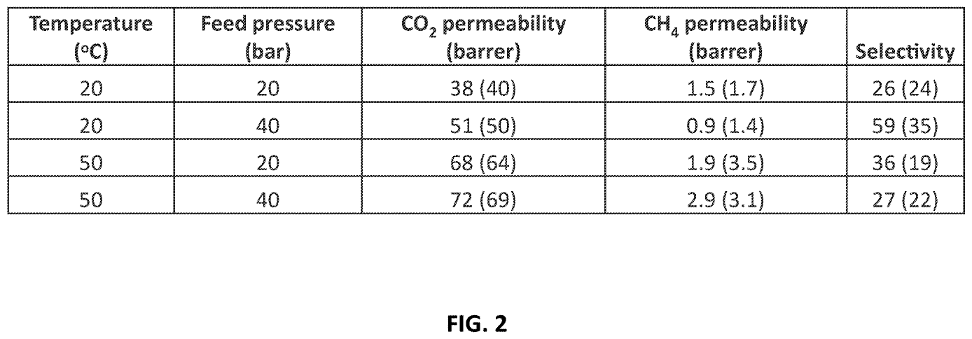

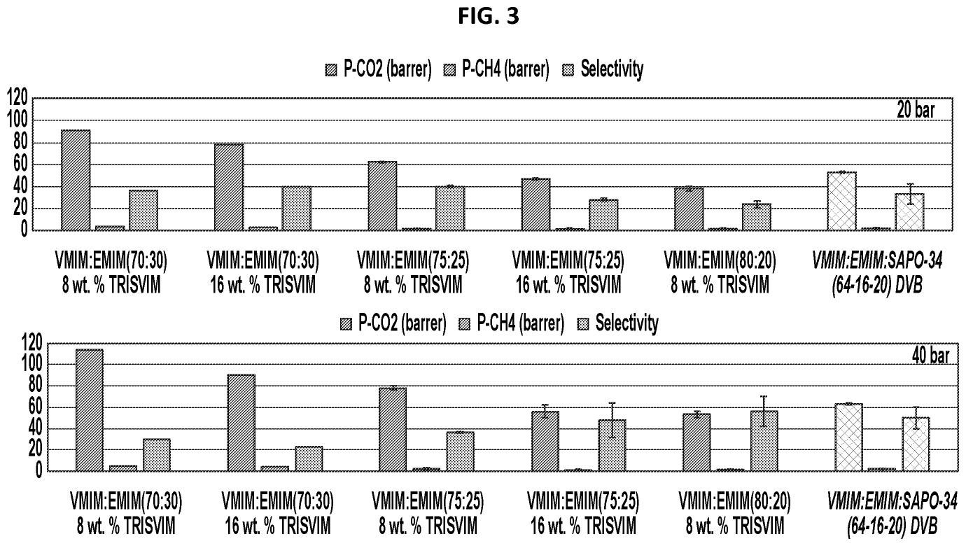

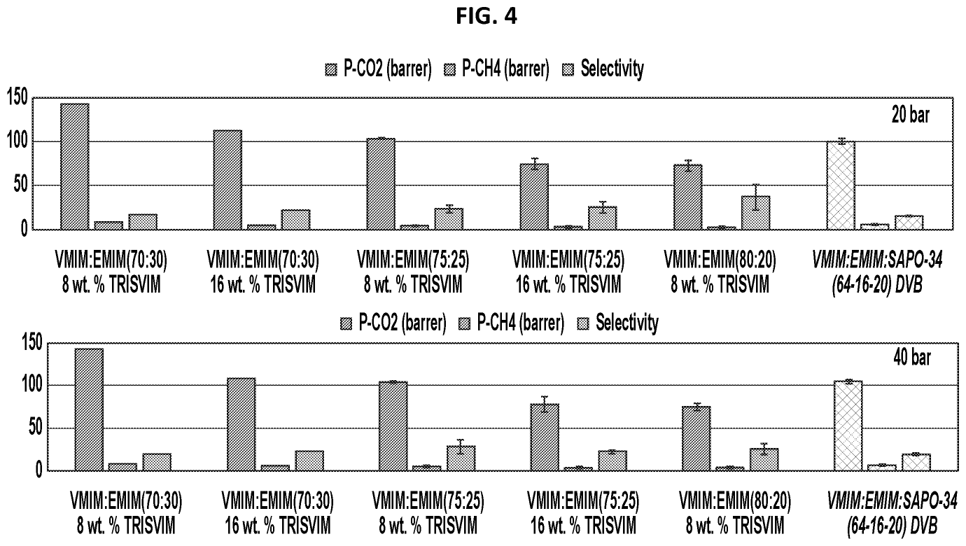

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo (carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O) C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀) hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo (carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O) C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀) hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═C═CCH₂, —CH—CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to aromatic and non-aromatic ring compounds containing three or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. The term heterocyclyl includes rings where a CH₂ group in the ring is replaced by one or more C═O groups, such as found in cyclic ketones, lactones, and lactams. Examples of heterocyclyl groups containing a C═O group include, but are not limited to, β-propiolactam, γ-butyrolactam, δ-valerolactam, and ε-caprolactam, as well as the corresponding lactones. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups. For example, a dioxolanyl ring and a benzdioxolanyl ring system (methylenedioxyphenyl ring system) are both heterocyclyl groups within the meaning herein. The phrase also includes polycyclic ring systems containing a heteroatom such as, but not limited to, quinuclidyl. Heterocyclyl groups can be unsubstituted, or can be substituted as discussed herein. Heterocyclyl groups include, but are not limited to, pyrrolidinyl, piperidinyl, piperazinyl, morpholinyl, pyrrolyl, pyrazolyl, triazolyl, tetrazolyl, oxazolyl, isoxazolyl, thiazolyl, pyridinyl, thiophenyl, benzothiophenyl, benzofuranyl, dihydrobenzofuranyl, indolyl, dihydroindolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Representative substituted heterocyclyl groups can be mono-substituted or substituted more than once, such as, but not limited to, piperidinyl or quinolinyl groups, which are 2-, 3-, 4-, 5-, or 6-substituted, or disubstituted with groups such as those listed herein.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure. A heteroaryl group designated as a C₂-heteroaryl can be a 5-ring with two carbon atoms and three heteroatoms, a 6-ring with two carbon atoms and four heteroatoms and so forth. Likewise a C₄-heteroaryl can be a 5-ring with one heteroatom, a 6-ring with two heteroatoms, and so forth. The number of carbon atoms plus the number of heteroatoms sums up to equal the total number of ring atoms. A heterocyclyl ring designated C_{x-y} can be any ring containing ‘x’ members up to ‘y’ members, including all intermediate integers between ‘x’ and ‘y’ and that contains one or more heteroatoms, as defined herein. In a ring designated C_{x-y}, all non-heteroatom members are carbon. Heterocyclyl rings designated C_{x-y} can also be polycyclic ring systems, such as bicyclic or tricyclic ring systems. Heteroaryl groups include, but are not limited to, groups such as pyrrolyl, pyrazolyl, triazolyl, tetrazolyl, oxazolyl, isoxazolyl, thiazolyl, pyridinyl, thiophenyl, benzothiophenyl, benzofuranyl, indolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Heteroaryl groups can be unsubstituted, or can be substituted with groups as is discussed herein. Representative substituted heteroaryl groups can be substituted one or more times with groups such as those listed herein.

Additional examples of aryl and heteroaryl groups include but are not limited to phenyl, biphenyl, indenyl, naphthyl (1-naphthyl, 2-naphthyl), N-hydroxytetrazolyl, N-hydroxytriazolyl, N-hydroxyimidazolyl, anthracenyl (1-anthracenyl, 2-anthracenyl, 3-anthracenyl), thiophenyl (2-thienyl, 3-thienyl), furyl(2-furyl, 3-furyl), indolyl, oxadiazolyl, isoxazolyl, quinazolinyl, fluorenyl, xanthenyl, isoindanyl, benzhydryl, acridinyl, thiazolyl, pyrrolyl(2-pyrrolyl), pyrazolyl (3-pyrazolyl), imidazolyl (1-imidazolyl, 2-imidazolyl, 4-imidazolyl, 5-imidazolyl), triazolyl (1,2,3-triazol-1-yl, 1,2,3-triazol-2-yl 1,2,3-triazol-4-yl, 1,2,4-triazol-3-yl), oxazolyl(2-oxazolyl, 4-oxazolyl, 5-oxazolyl), thiazolyl(2-thiazolyl, 4-thiazolyl, 5-thiazolyl), pyridyl(2-pyridyl, 3-pyridyl, 4-pyridyl), pyrimidinyl(2-pyrimidinyl, 4-pyrimidinyl, 5-pyrimidinyl, 6-pyrimidinyl), pyrazinyl, pyridazinyl (3-pyridazinyl, 4-pyridazinyl, 5-pyridazinyl), quinolyl(2-quinolyl, 3-quinolyl, 4-quinolyl, 5-quinolyl, 6-quinolyl, 7-quinolyl, 8-quinolyl), isoquinolyl (1-isoquinolyl, 3-isoquinolyl, 4-isoquinolyl, 5-isoquinolyl, 6-isoquinolyl, 7-isoquinolyl, 8-isoquinolyl), benzo[b]furanyl(2-benzo[b]furanyl, 3-benzo[b]furanyl, 4-benzo[b]furanyl, 5-benzo[b]furanyl, 6-benzo[b]furanyl, 7-benzo[b]furanyl), 2,3-dihydro-benzo[b]furanyl(2-(2,3-dihydro-benzo[b]furanyl), 3-(2,3-dihydro-benzo[b]furanyl), 4-(2,3-dihydro-benzo[b]furanyl), 5-(2,3-dihydro-benzo[b]furanyl), 6-(2,3-dihydro-benzo[b]furanyl), 7-(2,3-dihydro-benzo[b]furanyl), benzo[b]thiophenyl(2-benzo[b]thiophenyl, 3-benzo[b]thiophenyl, 4-benzo[b]thiophenyl, 5-benzo[b]thiophenyl, 6-benzo[b]thiophenyl, 7-benzo[b]thiophenyl), 2,3-dihydro-benzo[b]thiophenyl, (2-(2,3-dihydro-benzo[b]thiophenyl), 3-(2,3-dihydro-benzo[b]thiophenyl), 4-(2,3-dihydro-benzo[b]thiophenyl), 5-(2,3-dihydro-benzo[b]thiophenyl), 6-(2,3-dihydro-benzo[b]thiophenyl), 7-(2,3-dihydro-benzo[b]thiophenyl), indolyl (1-indolyl, 2-indolyl, 3-indolyl, 4-indolyl, 5-indolyl, 6-indolyl, 7-indolyl), indazole (1-indazolyl, 3-indazolyl, 4-indazolyl, 5-indazolyl, 6-indazolyl, 7-indazolyl), benzimidazolyl (1-benzimidazolyl, 2-benzimidazolyl, 4-benzimidazolyl, 5-benzimidazolyl, 6-benzimidazolyl, 7-benzimidazolyl, 8-benzimidazolyl), benzoxazolyl (1-benzoxazolyl, 2-benzoxazolyl), benzothiazolyl (1-benzothiazolyl, 2-benzothiazolyl, 4-benzothiazolyl, 5-benzothiazolyl, 6-benzothiazolyl, 7-benzothiazolyl), carbazolyl (1-carbazolyl, 2-carbazolyl, 3-carbazolyl, 4-carbazolyl), 5H-dibenz[b,f]azepine (5H-dibenz[b,f]azepin-1-yl, 5H-dibenz[b,f]azepine-2-yl, 5H-dibenz[b,f]azepine-3-yl, 5H-dibenz[b,f]azepine-4-yl, 5H-dibenz[b,f]azepine-5-yl), 10,11-dihydro-5H-dibenz[b,f]azepine (10,11-dihydro-5H-dibenz[b,f]azepine-1-yl, 10,11-dihydro-5H-dibenz[b,f]azepine-2-yl, 10,11-dihydro-5H-dibenz[b,f]azepine-3-yl, 10,11-dihydro-5H-dibenz[b,f]azepine-4-yl, 10,11-dihydro-5H-dibenz[b,f]azepine-5-yl), and the like.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

The term “heteroarylalkyl” as used herein refers to alkyl groups as defined herein in which a hydrogen or carbon bond of an alkyl group is replaced with a bond to a heteroaryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N (group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The terms “epoxy-functional” or “epoxy-substituted” as used herein refers to a functional group in which an oxygen atom, the epoxy substituent, is directly attached to two adjacent carbon atoms of a carbon chain or ring system. Examples of epoxy-substituted functional groups include, but are not limited to, 2,3-epoxypropyl, 3,4-epoxybutyl, 4,5-epoxypentyl, 2,3-epoxypropoxy, epoxypropoxypropyl, 2-glycidoxyethyl, 3-glycidoxypropyl, 4-glycidoxybutyl, 2-(glycidoxycarbonyl) propyl, 3-(3,4-epoxycylohexyl) propyl, 2-(3,4-epoxycyclohexyl)ethyl, 2-(2,3-epoxycylopentyl)ethyl, 2-(4-methyl-3,4-epoxycyclohexyl) propyl, 2-(3,4-epoxy-3-methylcylohexyl)-2-methylethyl, and 5,6-epoxyhexyl.

The term “monovalent” as used herein refers to a substituent connecting via a single bond to a substituted molecule. When a substituent is monovalent, such as, for example, F or Cl, it is bonded to the atom it is substituting by a single bond.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b}) hydrocarbyl, wherein a and b are integers and mean having any of a to b number of carbon atoms. For example, (C₁-C₄) hydrocarbyl means the hydrocarbyl group can be methyl (C₁), ethyl (C₂), propyl (C₃), or butyl (C₄), and (C₀-C_{b}) hydrocarbyl means in certain embodiments there is no hydrocarbyl group.

The term “solvent” as used herein refers to a liquid that can dissolve a solid, liquid, or gas. Non-limiting examples of solvents are silicones, organic compounds, water, alcohols, ILs, and supercritical fluids.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “room temperature” as used herein refers to a temperature of about 15° C. to 28° C.

The term “standard temperature and pressure” as used herein refers to 20° C. and 101 kPa.

Abbreviations used herein:
Tf₂N bis(trifluoromethylsulfonyl)imide, [(CF₃(SO₂)]₂N⁻;
VMIM 1-vinyl-3-methylimidazolium;
EMIM 1-ethyl-3-methylimidazolium;
DVB 1,4-divinylbenzene;
MMM mixed matrix membrane;
IL ionic liquid; and
PIL poly(ionic liquid).

### Preparation of Polymer and Membrane Compositions

The present disclosure provides, in one aspect, zeolite-free poly(ionic liquid) (PIL)-ionic liquid (IL) polymers and membranes cross-linked with an IL cross-linking agent.

The compositions described herein can be prepared by the general schemes described herein, using the synthetic method known by those skilled in the art. The following examples illustrate non-limiting embodiments of the compositions(s) described herein and their preparation.

In various embodiments, a composition is provided. The composition includes:
i) a polymerized ionic liquid (PIL) having the formula:

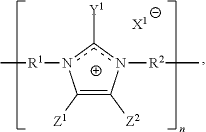

ii) a non-polymerized ionic liquid (IL) having the formula:

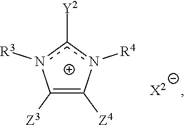

iii) an IL cross-linking agent having a formula selected from the group consisting of:

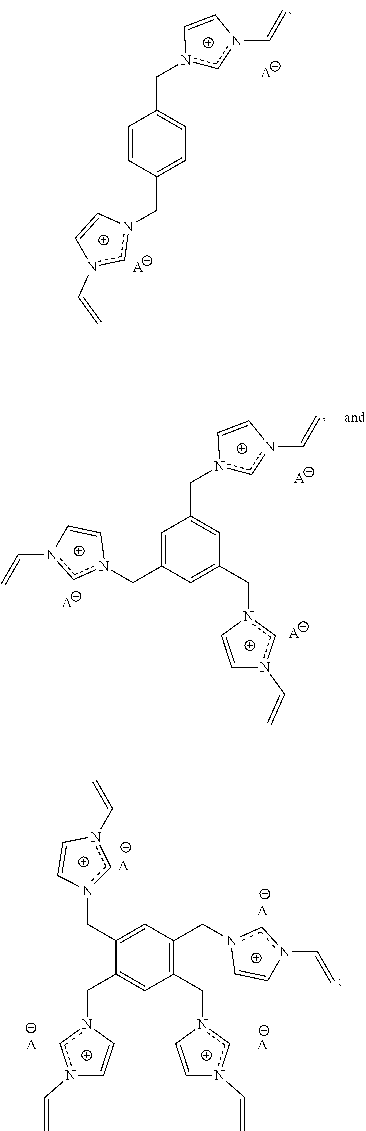

wherein:
   R¹, R², R³, and R⁴ are each independently selected from the group consisting of C₁₋₂₀ alkyl, C₂₋₂₀ alkenyl, C₂₋₂₀ alkynyl, C₆₋₂₀ aryl, and combinations thereof;
   X¹, X², and A are each independently anions;
   Y¹ and Y² are each independently hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
   Z¹, Z², Z³, and Z⁴ are each independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof;
   R is independently at each occurrence hydrogen or C₁₋₆ alkyl;
   n is an integer from 3 to 100,000.

In various embodiments, the PIL is cross-linked with the IL cross-linking agent. In various embodiments, the composition is free of zeolite. In various embodiments, the composition is free, or substantially free, of metal oxides, metal sulfides, and/or other metal salts. In various embodiments, the composition contains less than about 1, 0.9, 0.8, 0.7, 0.6, 0.5, 0.4, 0.3, 0.2, 0.1, 0.01, or about 0.001 wt % or less of zeolite. In some embodiments, the composition contains 0 wt % zeolite.

In various embodiments, Y¹, Y², Z¹, Z², Z³, and Z⁴ are each independently selected from the group consisting of hydrogen and C₁₋₄ alkyl. In various embodiments, Y¹, Y², Z¹, Z², Z³, and Z⁴ are each hydrogen. In various embodiments, R¹ is —CH₂CH₂— and R² is a —CH₂—. In various embodiments, R³ is methyl and R⁴ is ethyl. In various embodiments, Y¹, Y², Z¹, Z², Z³, and Z⁴ are each independently selected from the group consisting of methyl, ethyl, propyl, iso-propyl, n-butyl, sec-butyl, and tert-butyl.

In various embodiments, X¹, X², and A are each independently selected from the group consisting of F⁻, Cl⁻, Br⁻, BF₄⁻, SbF₆⁻, and Tf₂N⁻. In various embodiments, X¹, X², and A are each Tf₂N⁻.

In various embodiments, the IL is present in an amount of about 1-60 mol % relative to the amount of PIL. In various embodiments, the IL is present in an amount of about 10-40 mol % relative to the amount of PIL. In various embodiments, the IL is present in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 mol % relative to the amount of PIL.

In various embodiments, the IL cross-linking agent is present in amount of about 1 to about 25 mol % relative to the total of IL and PIL. In various embodiments, the IL cross-linking agent is present in amount of about 1, 2, 3, 4, 5, 6, 7, 8, 9, 10, 11, 12, 13, 14, 15, 16, 17, 18, 19, 20, 21, 22, 23, 24, or about 25 mol % relative to the total of IL and PIL. In various embodiments, the IL cross-linking agent is present in amount of 5 to 15 mol % relative to the total of IL and PIL. In various embodiments, the IL cross-linking agent is present in amount of about 5, 6, 7, 8, 9, 10, 11, 12, 13, 14, or about 15 mol % relative to the total of IL and PIL.

The PIL and IL can be present in the composition in a PIL:IL ratio of about 1:99, 5:95, 10:90, 15:85, 20:80, 25:75, 30:70, 35:65, 40:60, 45:55, 50:50, 55:45, 60:40, 65:35, 70:30, 75:25, 80:20, 90:10, 95:5, or 99:1. In various embodiments, the PIL is [VMIM][Tf₂N], the IL is [EMIM][Tf₂N], and the ratio of the PIL to the IL is about 80:20. In various embodiments, the PIL is [VMIM][Tf₂N], the IL is [EMIM][Tf₂N], and the ratio of the PIL to the IL is about 70:30.

The IL cross-linking agent can be present in the composition in an amount of about 1 wt % to about 25 wt %, about 3 wt % to about 20 wt %, about 4 wt % to about 18 wt %, or about 4, 5, 6, 7, 8, 9, 10, 11, 12, 13, 14, 15, 16, 17, 18, 19, 20, 21, 22, 23, 24, or about 25 wt % relative to the total weight of the composition.

In various embodiments a membrane is provided. The membrane, in some embodiments, has a first layer and an opposing second layer, wherein the first layer includes a PIL and an IL cross-linking agent, and wherein a non-polymerized IL is between the first and second layer. The PIL, IL, and the IL cross-linking agent in the membrane can be any of the respective agents described herein. In various embodiments, the membrane has a CO₂ permeability of at least 50 barrers. In various embodiments, the membrane has a CO₂/CH₄ selectivity of at least 10. In various embodiments, the membrane has a CO₂ permeability at least about 50, 55, 60, 65, 70, 75, 80, 85, 90, 95, 100, 105, 110, 115, 120, 125, 130, 135, 140, 145, or about 150 barrers. In various embodiments, the membrane has a CO₂/CH₄ selectivity of at least about 10, 15, 20, 25, 30, 35, or 40.

In various embodiments, the second layer includes a PIL and an IL cross-linking agent, and wherein an non-polymerized IL is between the first and second layer. In various embodiments, the second layer is a mechanical support layer. The mechanical support layer can be made of plastic, metal, or a combination thereof. The mechanical support layer is, in some embodiments, sufficiently porous to allow gas passing through the first layer to flow unimpeded.

In various embodiments, a third layer is present between the first layer and second layer.

The membrane, including both the first and second layers, can be, in various embodiments, about 0.01 to about 350, about 50 to about 250, or about 100 to about 200 μm thick. In various embodiments, the membrane can be about 0.01, 0.02, 0.03, 0.04, 0.05, 0.06, 0.07, 0.08, 0.09, 0.1, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, or about 350 μm thick. In various embodiments, the first layer can be about 0.01, 0.02, 0.03, 0.04, 0.05, 0.06, 0.07, 0.08, 0.09, 0.1, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or about 200 μm thick. In various embodiments, the second layer can be about 0.01, 0.02, 0.03, 0.04, 0.05, 0.06, 0.07, 0.08, 0.09, 0.1, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, or about 200 μm thick.

In various embodiments, the IL cross-linking agent has at least one of the following structures:

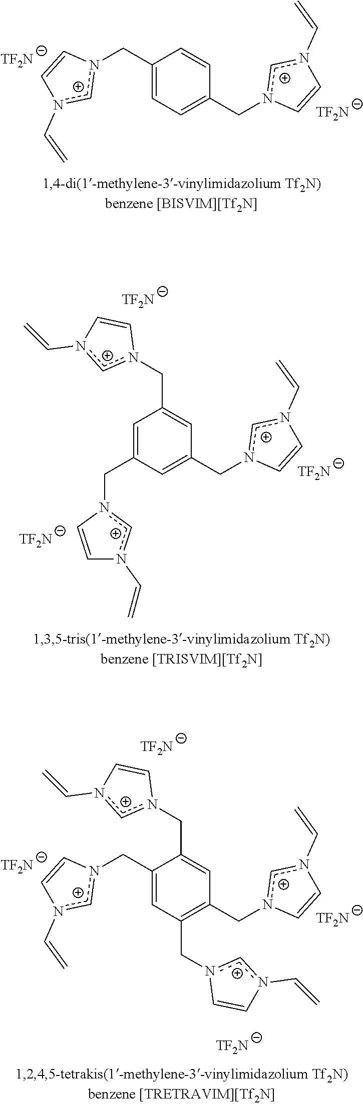

In various embodiments, IL cross-linking agents described herein can be synthesized according to Scheme 1.

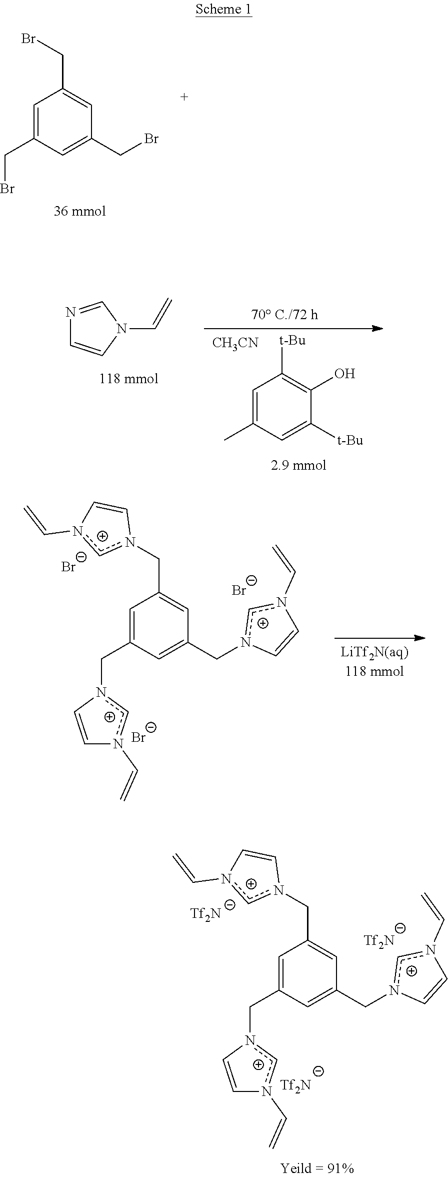

In various embodiments, a polymer of Formula Z, is provided:

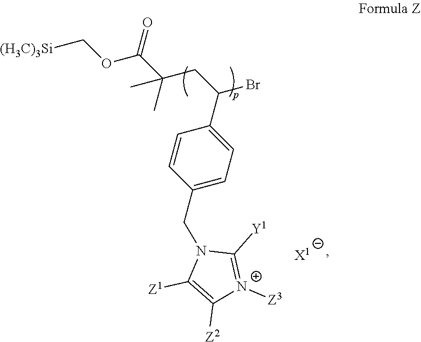

wherein:
X¹ is an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², and Z³ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof; and
p is an integer from 1 to 40.

In various embodiments, in the polymer of Formula Z, Y¹, Z¹, and Z² are hydrogen.

In various embodiments, p in the polymer of Formula Z is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In various embodiments, in the polymer of Formula Z, X¹ can be any of anions described herein. In various embodiments, X¹ in the polymer of Formula Z is selected from the group consisting of F⁻, Cl⁻, Br⁻, BF₄⁻, SbF₆⁻, and Tf₂N. In various embodiments, X¹ in the polymer of Formula Z is Tf₂N⁻. In various embodiments, in the polymer of Formula Z, p is 10, 11, 12, 13, 14, 15, 16, 17, 18, 19, 20, 21, 22, 23, 24, 25, 26, 27, 28, 29, or 30.

In various embodiments, Y¹, Z¹, Z², Z³, and Z⁴ in the polymer of Formula Z are each independently selected from the group consisting of C₁, C₂, C₃, C₄, C₅, C₆, C₇, C₈, C₉, C₁₀, C₁₁, C₁₂ alkyl, and all branched and/or linear isomers thereof. In various embodiments, Y¹, Z¹, Z², Z³, and Z⁴ in the polymer of Formula Z are each independently selected from the group consisting of hydrogen, and C₁₋₄ alkyl. In various embodiments, Y¹, Z¹, Z², Z³, and Z⁴ in the polymer of Formula Z are each independently selected from the group consisting of methyl, ethyl, propyl, iso-propyl, n-butyl, sec-butyl, and tert-butyl. In various embodiments, in the polymer of Formula Z, Z³ is n-butyl.

In various embodiments, a polymer of Formula ZZ is provided:

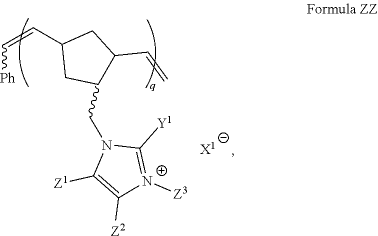

wherein:
X¹ is an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², and Z³ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof; and
q is an integer from 1 to 40.

In various embodiments, in the polymer of Formula ZZ, Y¹, Z¹, and Z² are hydrogen.

In various embodiments, q in the polymer of Formula ZZ is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40.

In various embodiments, in the polymer of Formula ZZ, X¹ can be any of anions described herein. In various embodiments, X¹ in the polymer of Formula ZZ is selected from the group consisting of F⁻, Cl⁻, Br⁻, BF₄⁻, SbF₆⁻, and Tf₂N⁻. In various embodiments, X¹ in the polymer of Formula ZZ is Tf₂N⁻. In various embodiments, in the polymer of Formula ZZ, q is 10, 11, 12, 13, 14, 15, 16, 17, 18, 19, 20, 21, 22, 23, 24, 25, 26, 27, 28, 29, or 30.

In various embodiments, Y¹, Z¹, Z², Z³, and Z⁴ in the polymer of Formula Z are each independently selected from the group consisting of C₁, C₂, C₃, C₄, C₅, C₆, C₇, C₈, C₉, C₁₀, C₁₁, C₁₂ alkyl, and all branched and/or linear isomers thereof. In various embodiments, Y¹, Z¹, Z², Z³, and Z⁴ in the polymer of Formula Z are each independently selected from the group consisting of hydrogen, and C₁₋₄ alkyl. In various embodiments, Y¹, Z¹, Z², Z³, and Z⁴ in the polymer of Formula Z are each independently selected from the group consisting of methyl, ethyl, propyl, iso-propyl, n-butyl, sec-butyl, and tert-butyl. In various embodiments, in the polymer of Formula ZZ, Z³ is n-pentyl. In various embodiments, in the polymer of Formula ZZ, Z³ is n-hexyl.

The polymers of Formula Z and ZZ can be used alone, or in combination with any of the ionic materials described herein. For example, in various non-limiting embodiments, polymers of Formula Z and/or Formula ZZ can be used in the methods described herein for separating a first gas component from a gas mixture containing at least a first and a second gas component.

The compositions described herein, and other related compositions having different substituents are synthesized using techniques and materials described herein and as described, for example, in Fieser & Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991), Larock's Comprehensive Organic Transformations (VCH Publishers Inc., 1989), March, Advanced Organic Chemistry 4^{th} Ed., (Wiley 1992); Carey & Sundberg, Advanced Organic Chemistry 4th Ed., Vols. A and B (Plenum 2000, 2001), and Green & Wuts, Protective Groups in Organic Synthesis 3rd Ed., (Wiley 1999) (all of which are incorporated by reference for such disclosure). General methods for the preparation of compositions as described herein are modified by the use of appropriate reagents and conditions, for the introduction of the various moieties found in the formula as provided herein.

Compositions described herein are synthesized using any suitable procedures starting from compounds that are available from commercial sources, or are prepared using procedures described herein.

### Methods of Gas Separation

In various embodiments, a method for separating a first gas component from a gas mixture containing at least a first and a second gas component, is provided. The method includes the steps of:
a) providing a membrane having a feed and a permeate side and being selectively permeable to the first gas component over the second gas component;
b) applying a feed stream including the first and the second gas components to the feed side of the membrane; and
c) providing a driving force sufficient for permeation of the first gas component through the membrane, thereby producing a permeate stream enriched in the first gas component from the permeate side of the membrane; wherein the membrane is composed of any of the cross-linked compositions described herein.

The feed stream, in various embodiments, can include two or more gases such as CO₂, H₂O (vapor), N₂, H₂, CO, CH₄, O₂, and combinations thereof. In various embodiments, the first gas component is CO₂ and the second gas component is CH₄. In various embodiments, the first gas component is CO₂ and the second gas component is N₂. In various embodiments, the first gas component is CO₂ and the second gas component is H₂.

Without being bound by theory, the separation selectivity and permeability of the membranes described herein is due to at least in part to the pores formed in the membrane by the polymers and cross-linkers described herein, as well as the electrostatic environment formed in the compounds described herein. Thus, the selective separation of CO₂ described herein is, in various embodiments, not due to an adsorption/desorption process. The membranes can be used in various devices, such as fuel cells.

### EXAMPLES

Various embodiments of the present application can be better understood by reference to the following Examples which are offered by way of illustration. The scope of the present application is not limited to the Examples given herein.

### General Procedure for Synthesis of PIL-IL-Cross-Linker Membranes

The particular components of the membrane are mixed in a vial using mechanical stirring for 1 h to obtain a homogenous mixture. In various embodiments, heating is not required for the mixtures containing the tri-functional cross-linker [TRISVIM][Tf₂N]. However, the mixtures needs heating if di/tetra-functional cross-linkers are used.

Once the components are mixed well, the radical polymerization initiator is added and mixed for another 10 min. Next, the above mixture is poured onto a clean glass plate and covered with another similar clean glass plate.

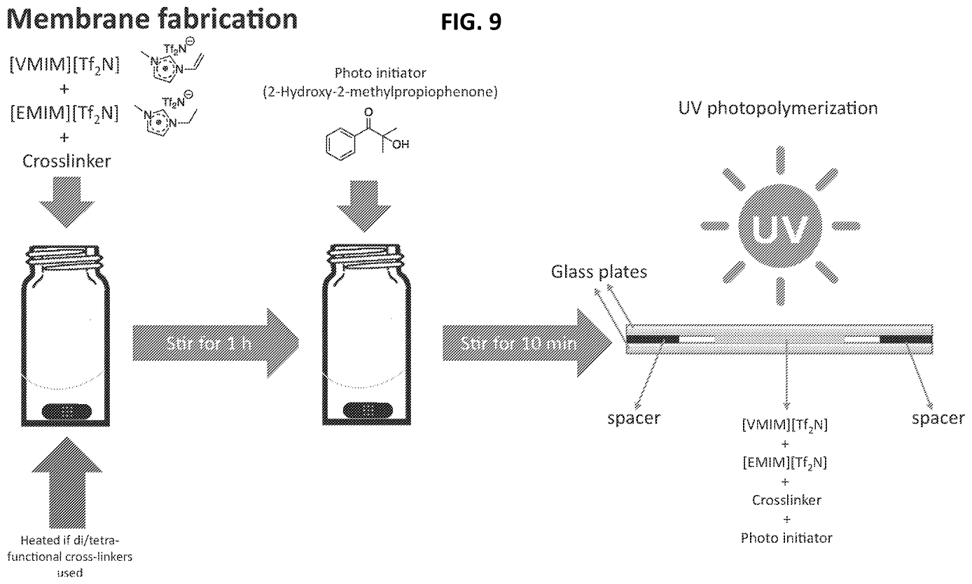

To obtain a membrane with a constant thickness two spacers of the same thickness is placed in between the glass plates as described in the figure in FIG. 9. To keep the glass plates from moving they are clamped together using three clamps as well. After that, the photopolymerization of the PIL-IL-Cross-linker mixture is initiated using UV light. Typically, the UV photopolymerization is carried out for 5 h.

Before testing for gas separation performance, the membrane is annealed at 50° C. under vacuum for ~24 h in a vacuum oven.

Example conditions for PIL-IL-cross-linked membranes are described in Table 1:

TABLE 1
Experimental conditions for synthesis of PIL-IL-cross-linked membranes

| | PIL-IL (80:20) | | PIL-IL (70:30) | |
|---|---|---|---|---|
| | membrane | | membrane | |
| | with 8% (w/w) | | with 8% (w/w) | |
| Reagent | cross-linker | | cross-linker | |
| [VMIM][Tf₂N] | 0.4 | g | 0.35 | g |
| [EMIM][Tf₂N] | 0.1 | g | 0.15 | g |
| TRISVIM][Tf₂N] | 0.0048 | g | 0.0048 | g |
| photoinitiator | 4.64 | μL | 4.64 | μL |

The photoinitator can be any suitable photoinitiator such as 2-hydroxy-2-methylpropiophenone. Other suitable photoinitiators include, but are not limited to, 1-hydroxycyclohexyl phenyl ketone, 1-[4-(2-hydroxyethoxy)-phenyl]-2-hydroxy-2-methyl-1-propane-1-one, oligo[2-hydroxy-2-methyl-1-[4-(1-methylvinyl)phenyl]propanone, and the like.

### Charged Oligomers and Charged Polymer-Blend Materials

The overall objective is to the incorporation of charged oligomers of specific lengths (i.e., with a specific number of repeat units) into charged polymer structures to enhance resistance to plasticization and reduce aging effects in membranes made from these polymers for improved gas separation performance. The rationale is that charged oligomers within charged polymer structures will be more beneficial than conventional uncharged polymer blends due to the electrostatic attractions between the charged oligomers and ionic polymer as well as mutual miscibility of the components. The length (i.e., number of repeat units) of the added charged oligomer is an important variable that will affect resistance to plasticization and aging because the number of electrostatic interactions between the oligomer with the polymer should enhance the resistance of the membrane structure to gas pressure and operating temperature. However, as the oligomer length is increased, the membrane permeability will decrease at some length because the membrane has more polymer and less liquid-like component in the composite structure.

When polymer membranes are prepared as a thin-film composite (TFC) or a coating on a support for gas separations, the resulting membrane is almost always in a non-equilibrium morphology. This is because glassy polymer materials have typically been used for gas separation applications. Thus, the initial gas or vapor permeation performance will change over time as the morphology changes. This change is driven by two effects: plasticization and aging.

Plasticization is caused when condensable gases and/or vapors diffuse into the membrane structure, causing a swelling effect that increases the polymer fractional free volume at high partial pressures of the penetrating gas or vapor. The result is an overall increase in membrane permeability and a loss in selectivity as a function of time. Different penetrants will generate this effect to different levels, as it is a general effect that is not related to just one gas/vapor.

Physical aging is a phenomenon observed in glassy materials where change in a property is observed as a function of storage time without any influence from any other external conditions. This phenomenon is due to the fact, as mentioned before, that the material structure is typically out-of-equilibrium. A wide range of properties, including both bulk properties, such as specific volume, enthalpy, mechanical, and dielectric response, as well as properties at the molecular level, such as the free volume distribution, can be affected.

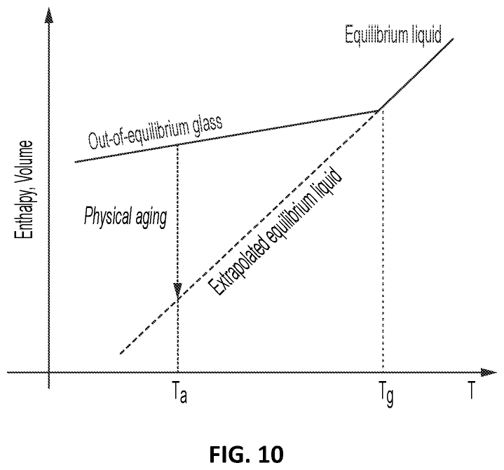

Physical aging can be illustrated by what happens when an amorphous polymer is cooled from above to below its glass transition temperature (T_{g}) (FIG. 10). The non-equilibrium state of glassy polymers below the T_{g} can be schematically represented as a plot of enthalpy (or volume) as a function of temperature. Below the T_{g}, the polymer has excess enthalpy or free volume with respect to its equilibrium state. As long as the polymer is kept at a temperature (Ta) that is below the T_{g}, the thermodynamically stable state (as represented by the broken line) is slowly but indefinitely recovered during the course of physical aging as the polymer attempts to reach the equilibrium state. The lowering of cooperative molecular mobility with decreasing temperature is often cited as the main reason for the inability of the glassy polymer to follow the line of the equilibrium structure.

A key interplay between these two effects is that plasticization can induce more rapid aging since the membrane morphology can be displaced during plasticization with subsequent relaxation towards lower energy minima upon reduction in gas pressure. It has been shown that aging can be retarded if the membrane is kept at high pressure rather than cycled (Ma and Koros, 2018).

There have been different methods previously studied in attempts to reduce these effects on membrane effective lifetime and performance. The approaches most often studied are the use of an additive to the polymer (i.e., blends) as well as cross-linking of the polymer (Merrick et al., 2020; Panapitiya et al., 2016; Hosseini et al., 2010). Each will be discussed below.

Polymer blends have been previously studied as a proposed solution to the problem of plasticization and aging. They have not been very successful to date due to several issues (Merrick et al., 2020; Kapantaidakis et al., 2003): One is the miscibility of the components. If the polymer and additive are not miscible, then factors such as phase separation will have a negative influence on any enhancement of the resulting properties and performance. Another factor is the size of the additive relative to the polymer. This includes both the absolute size as well as the size distribution. These factors can lead to non-uniformities in the polymer structure. We anticipate that the use of a charged polymer matrix and controlled-length charged oligomers with a narrow mol. wt. distribution will reduce or eliminate these issues since the electrostatic attractions between the two charged components will induce miscibility and cooperative interactions. We will specifically use ionic oligomers with a narrow mol. wt. distribution to provide a means to evaluate oligomer length as a variable controlling membrane stability and performance and to determine if there is an optimal range for this parameter.

Cross-linking is another approach for reducing membrane aging by stabilizing a single structure (Ma and Koros, 2018). Cross-linking typically involves the formation of covalent bonds between polymer strands. These linkages rigidify the structure and reduce the swelling effect when the membrane is pressurized. As the structure is cross-linked, the membrane permeability typically is reduced, and the selectivity can be increased. However, it is also possible to form strong non-covalent cross-links between polymer chains via hydrogen bonding or charge-charge attractions, so the use of additional forces besides covalent bonds to control and stabilize the morphology can provide a means to maintain a higher permeability while keeping the selectivity at the desired value.

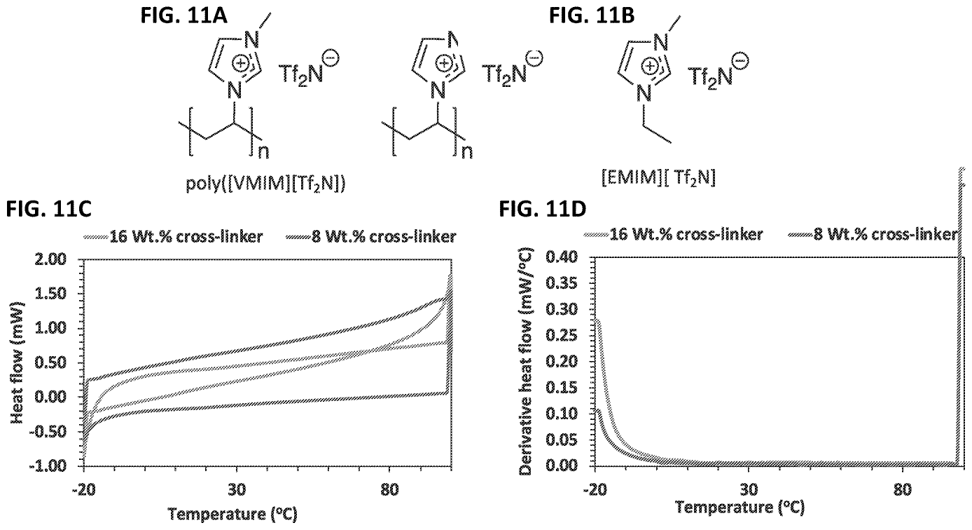

Polymer membranes can be used to separate CO₂ from N₂ and CH₄. However, traditional polymeric materials are limited by the so-called permeability-selectivity trade-off. These membranes perform the gas separation due to diffusion selectivity. As the membrane permeability increases, the polymer structure becomes more open and selectivity decreases. However, polymerized ionic liquid (PIL)-ionic liquid (IL) membrane technology has been identified as a successful alternative to traditional polymer membranes (Bara et al., 2007, Bara et al., 2010 and Cowan, Gin et al. 2016). ILs are chemical compounds completely composed of anions and cations (organic, inorganic, or mixed) with melting points below 100° C. IL-based membrane materials exhibit high CO₂ permeabilities compared to traditional polymer membranes because of the higher intrinsic solubility of CO₂ in IL-based materials. Higher CO₂/light gas selectivities are also observed compared to conventional polymeric materials, which perform separations primarily based on diffusivity differences whereas IL-based membranes primarily utilize gas solubility differences for CO₂/light gas separations. Both the PIL and IL components can be very similar in chemical structure (see FIGS. 11A-11D). So, as more IL is added to the membrane, the gas diffusion increases while the gas selectivity remains very similar. Thus, there is not a permeability-selectivity trade-off with these membranes. The IL component is stable in the composite membrane due to the strong electrostatic interactions between the charged IL and PIL components.

Linear PIL-IL ion-gel membranes can be made with a maximum loading of 15 wt. % free IL. Membranes with IL loadings >15 wt. % suffer from poor mechanical stability and aren't suitable for real applications. Alternatively, cross-linked PIL-IL can be used to fabricate membranes with increased free IL content (≥75 wt. %). The gas transport properties of these membranes can be tuned by modifying the cross-linked PIL and free IL structures (Cowan, Gin et al. 2016). In addition, curable PIL systems were identified as a further improvement in PIL-IL technology. This technology allows the defect-free fabrication of PIL-IL thin-film membranes containing ≥80 wt. % free IL that can operate at low feed pressures and ambient temperature.

Plasticization and aging are common issues in the processing of many permanent gases as shown below.

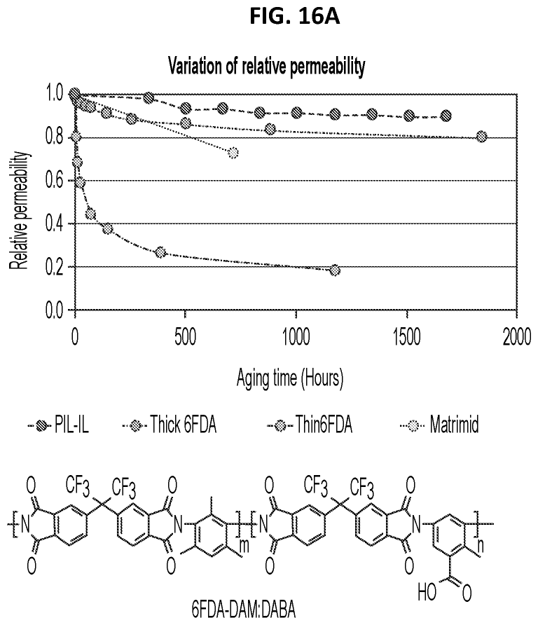

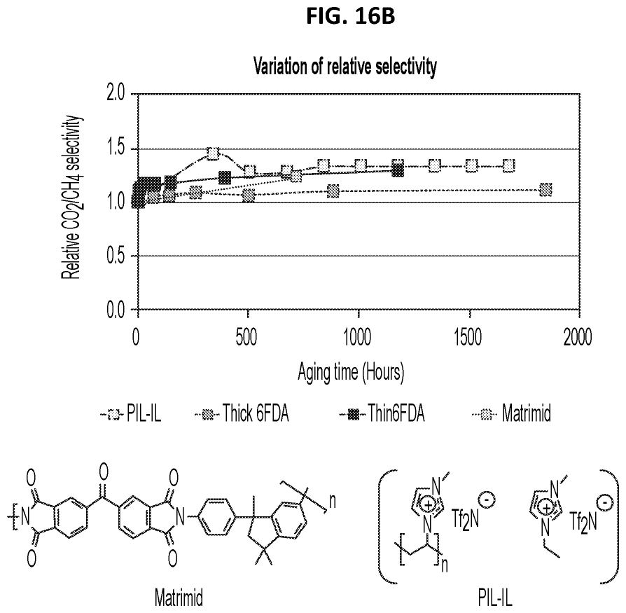

The most important issues for membrane-based gas separations are plasticization and aging of the membrane material as stated above. It has been hypothesized that ionic polymer membranes are generally in equilibrium structures, so they do not suffer from aging (Simons et al., 2010). Recent results to support this hypothesis are shown below (FIGS. 11A-11D & 7). FIGS. 11A-11D illustrates the thermal behavior of two PIL-IL membranes as analyzed by differential scanning calorimetry (DSC). These DSC curves confirms the absence of a glass transition temperature (T_{g}) in the temperature range-20 to 100° C. However, glass transition temperatures for neat PILs have previously been reported (Bocharova et al., 2017). By mixing the IL with PIL generates a material with an undetectable T_{g}, because a T_{g} for different ILs have been reported far below the temperature range used in this study [Mirkhani et al., 2012; Valderrama et al., 2017; Bocharova et al., 2017]. In addition, CO₂ permeability at 50° C. and 40 bar feed pressure showed no significant decrease over time unlike in glassy polymers (FIGS. 16A-16B). The absence of a T_{g} (FIGS. 11A-11D) and the small variation of permeabilities over time (FIGS. 16A-16B) suggest that our PIL-IL membranes are in an equilibrium state. Because the ionic polymer membranes are equilibrium or near-equilibrium structures, unlike neutral polymer membranes, the use of an ionic oligomer additive of controlled length can increase the ability of the membrane to resist the plasticization effect of high gas pressure due to the favorable electrostatic interactions between the charged polymer and oligomer elements of the membrane. Unlike in PIL-IL systems, PIL-(IL oligomer) structures are expected to exhibit a T_{g}.

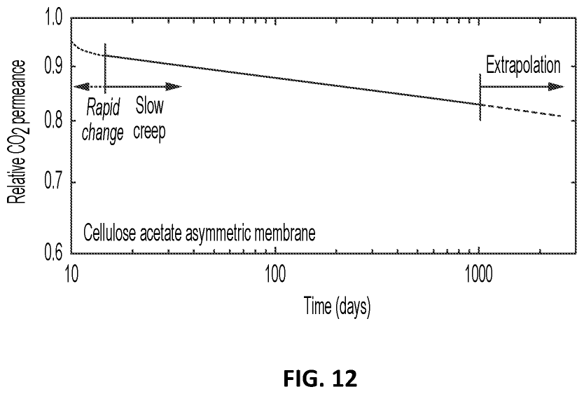

For conventional uncharged polymer membranes, FIG. 12 is illustrative for a cellulose acetate (CA) membrane (Merrick et al., 2020). Note that there is a rapid decrease in permeance over approximately two weeks followed by a slower reduction over a much longer time period. Continuous operation tends to reduce the temporal effect so periodic testing should see a much more rapid decline than shown in FIG. 12; thus, FIG. 12 should be taken as an example of a minimal effect of temporal decline in conventional polymers.

Physical aging in glassy polymers such as Matrimid® and 6FDA-based polymers have been a commonly discussed topic in literature (Merrick et al., 2020). In general, glassy polymer membranes show a decrease in gas flux over time when tested below the T_{g}. The main reason for this is the relaxation of polymer chains over time, which causes the polymer to lose free volume (Huang and Paul, 2004). This phenomenon can be monitored using single/mixed gas permeation using a polymer membrane. In most cases, gases such as N₂, O₂, and CH₄ have been used as the feed gasses (Rowe et al. 2009). CO₂ has not been widely used to do these long-term studies because of the ability of CO₂ to change the glassy state of many polymers (Huang and Paul, 2004; Chiou et al., 1985).

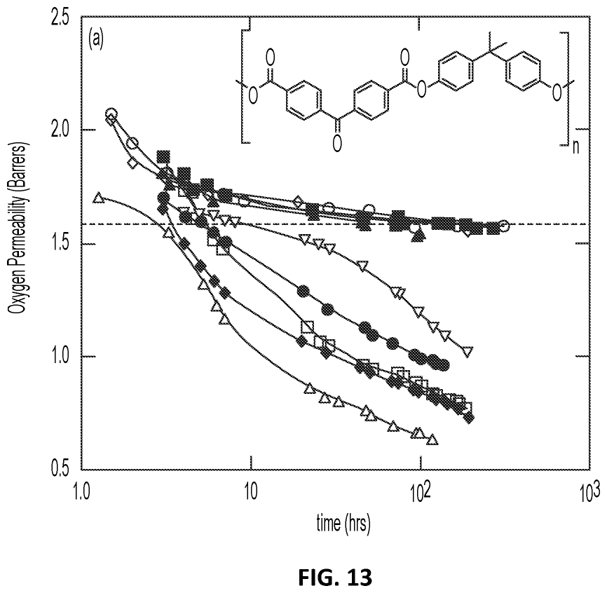

McCaig and Paul (2000) studied the physical aging behavior of a glassy polyacrylate (made from bisphenol-A benzophenone dicarboxylic acid). All membrane films were heated above the glass transition temperature (T_{g}~194° C.) before testing. They studied single-gas N₂ and O₂ permeability variation of films with varying thickness (0.25-33 μm) over time. They used a testing temperature of 35° C. and a feed pressure of 2 bar. According to their results, thinner films (thickness<2 μm) exhibited greater change in permeability over time (FIG. 13). For thicker films (thickness>2 μm), the majority of permeability reduction occurs in the first 10 h, which slows down thereafter (FIG. 13). For instance, the thinnest membrane (0.25 μm) lost ~65% of the initial O₂ permeability, whereas the thickest membrane (33 μm) lost only ~25%. Due to the equilibrium or near-equilibrium state of PIL-(IL oligomer) structures, these structures will not exhibit any dramatic changes in permeability with time as a function of membrane thickness.

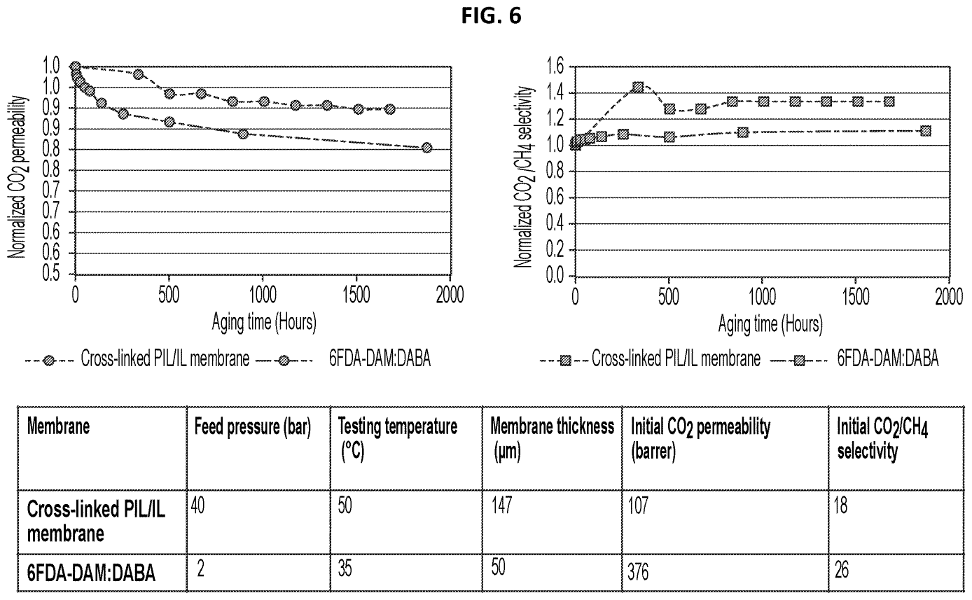

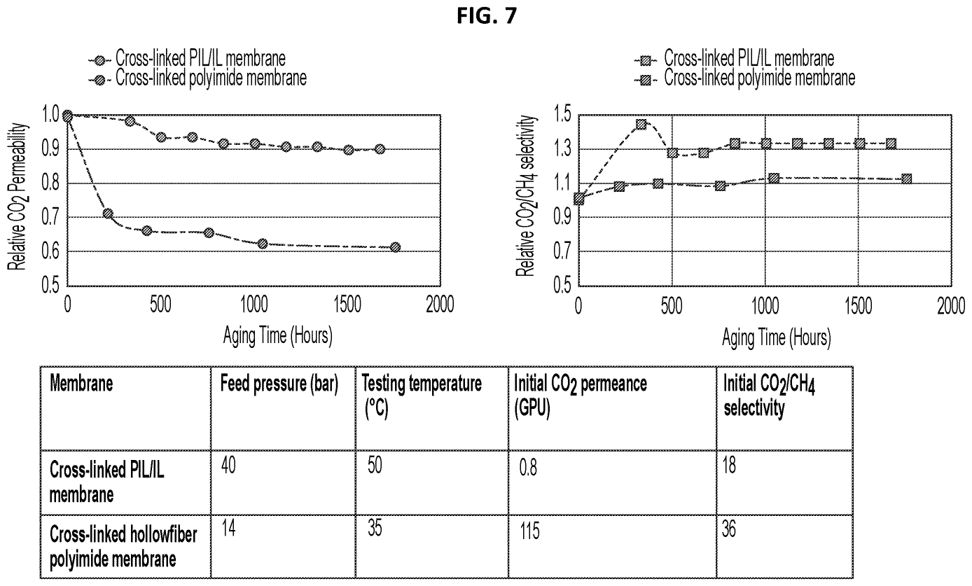

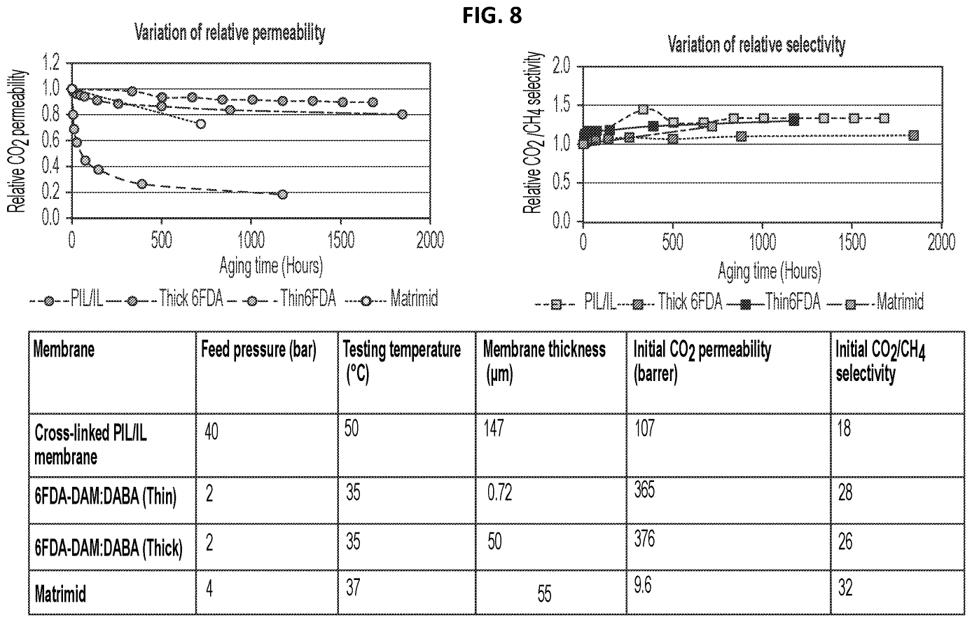

Huang and Paul (2004) studied the physical aging behavior of polymer membranes made of common glassy polymers such as polysulfone (PSF), Matrimid®, and poly(2,6-dimethyl-1,4-phenylene oxide) (PPO). For their studies they used films with thicknesses varying from 300 nm to 60 μm. The measurements were made at 35° C. and 2 bar feed pressure using CH₄, O₂, and N₂. FIG. 6 shows the variation of O₂ permeabilities for PSF, Matrimid®, and PPO with time. Table 2 summarizes the percent reduction of O₂ permeability after 200 h for each polymer (for highest and lowest thickness).

TABLE 2
Percent reduction of O₂ permeability after 200 h for different
polymer membranes (Huang and Paul, 2004).

| Membrane | % Reduction in O₂ Permeability |
|---|---|
| (thickness) | after 200 h |
| PSF (61.2 μm) | 10 |
| PSF (413 nm) | 24 |
| PPO (25.2 μm) | 10 |
| PPO (400 nm) | 41 |
| Matrimid ® (3.5 μm) | 13 |
| Matrimid ® (392 nm) | 30 |

Unlike conventional uncharged polymer membranes, charged PILs are less susceptible to plasticization (Simons et al., 2010). This is mainly due to the strong ionic interactions between PIL chains, which prevents the swelling of the polymer matrix. However, at extremely high CO₂ feed pressure (>20 bar) and higher temperatures (>40° C.) PILs show plasticization as observed from gas permeabilities (Simons et al., 2010). However, the plasticization did not lead to a change in permeability with cycling, suggesting reversible expansion. This was assumed to be due to the electrostatic interactions of the polymer units which allow the membrane to return to its equilibrium state after each cycle.

### Experimental Approach to Developing Membrane and Polymer Materials Described Herein

There are a number of experimental methods that can be used for these proposed evaluations of membrane materials with respect to plasticization and aging. Variable-temperature dynamic mechanical analysis will be used to measure the mechanical properties of the various ionic polymer and ionic polymer/additive materials to determine if they have a T_{g} in the temperature range studied.

Variable-temperature AC-impedance-based ionic conductivity measurements can be used to evaluate the temperature and gas pressure range where the electronic interactions are strong and maintain the structural integrity of the material. When the charge locations are moved further apart or the electrostatic attractions are disrupted due to increased gas pressure and/or temperature, the ionic conductivity of the material will increase, and this will identify a limit in material properties (Cowan et al., 2016; Lopez et al., 2018).

Single- and mixed-gas permeation experiments as a function of gas feed pressure, composition, and temperature can be used to determine the appropriate operating range for the various materials tested. These experiments can be conducted with both neutral and charged materials to ascertain the operating range where the charged materials have a benefit. These results can also be used to demonstrate the limitations of a Robeson plot where all the gas permeability vs. selectivity data are plotted for single-gas permeation experiments at ambient temperature and pressure.

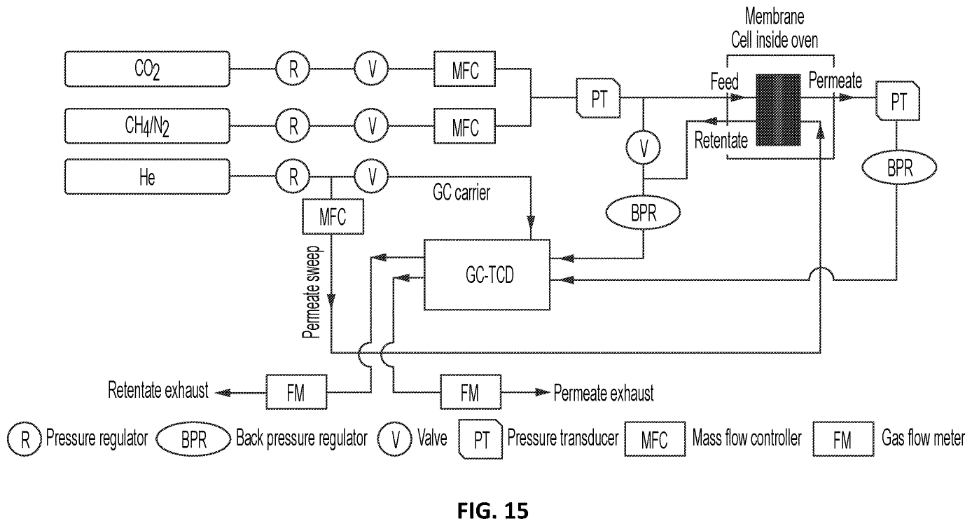

A time-lag gas permeation apparatus as shown in FIG. 15 will be used to measure the transport characteristics of the membrane prepared in this study.

The gas permeability will be measured using a custom-built apparatus (Dunn et al., 2020, FIG. 15) equipped for high pressures and binary gas feeds (CO₂/CH₄ or CO₂/N₂). In this apparatus, a circular piece of membrane can be loaded into the steel testing cell kept inside a temperature-controlled oven (Yamato DX 300). To prevent leaks from the feed side to the permeate side a rubber gasket is placed on top of the membrane and the cell will be tightly screwed. Mass flow controllers (MFCs) attached to CO₂ and CH₄/N₂ gas cylinders allow the feed flowrate and composition to be controlled via Lab View software. The feed and retentate gas composition are assumed to be equal because the feed flowrate is orders of magnitude higher than the permeation flowrate. A back-pressure regulator on the feed side was used to maintain the desired feed pressure, and digital pressure transducers are placed at both feed and permeate sides to monitor pressure. A third MFC is used to apply a sweep stream of He to the permeate side. Both the feed/retentate stream and the permeate stream are monitored by an in-line SRI 8610C gas chromatograph (GC) equipped with a 6-m-long Haysep D column operating at 50° C. Permeate and retentate flowrates are determined using bubble flow meters and a stopwatch. The combination of GC composition data, flowrates, and pressures will be used to calculate gas permeabilities and respective selectivities. We will initially test the performance of composite membranes at temperatures ranging between 293-308 K and at feed pressure of a few bar. Once this is completed, we can conduct mixed-gas permeation measurements up to 40 bar feed pressure and 50° C. temperature.

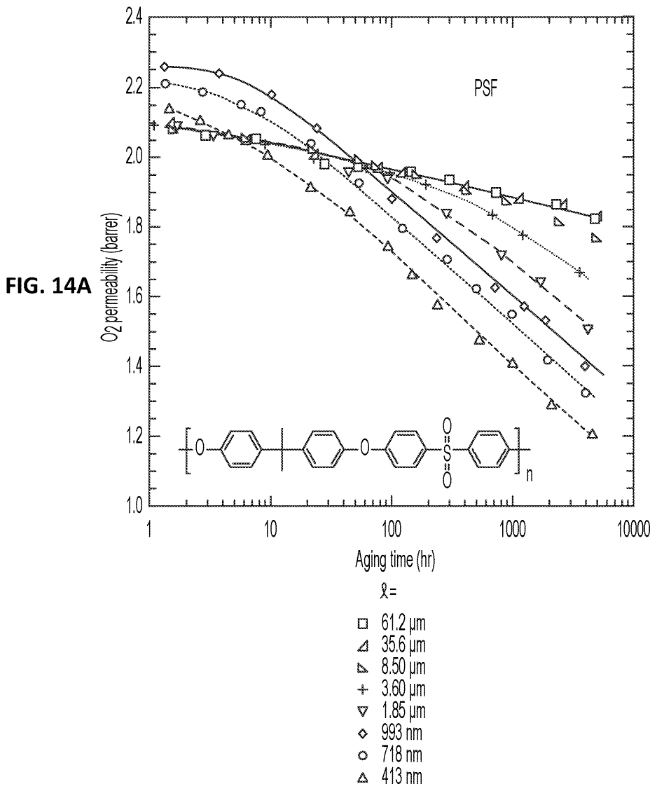

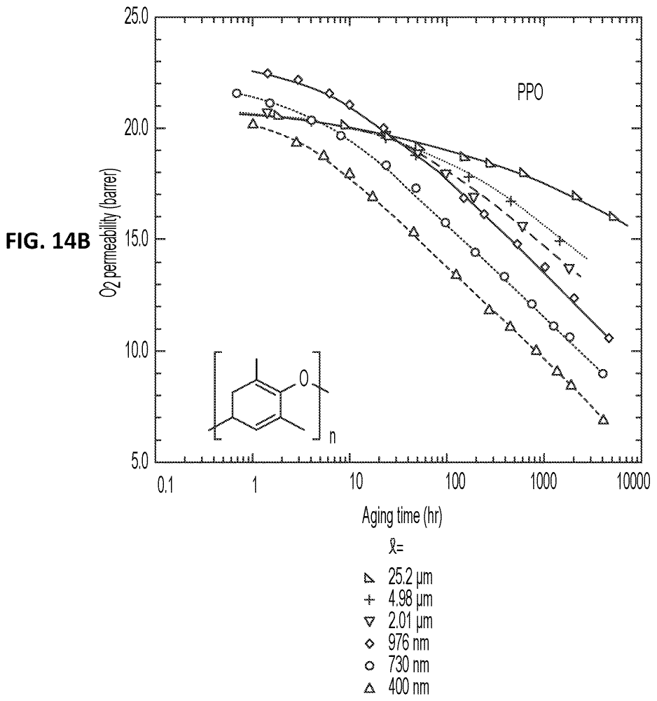

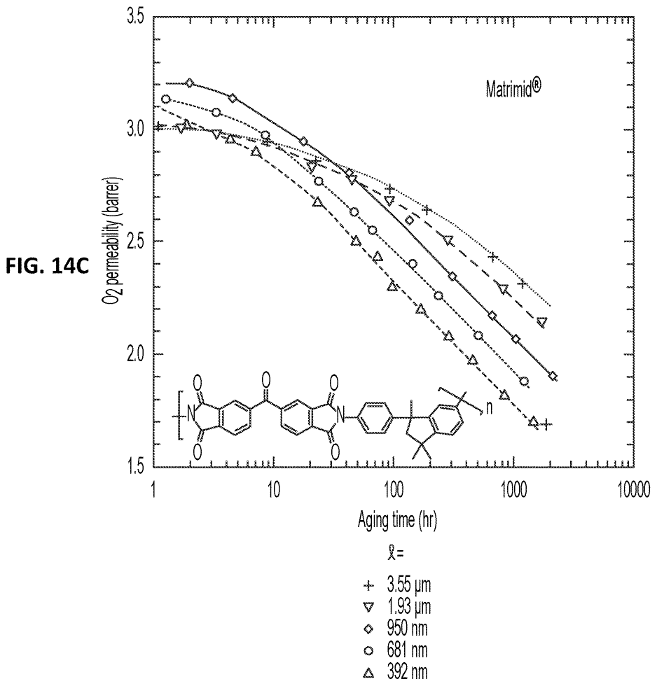

Initially, we will study thick (free standing) films using CO₂ as the feed gas (usually the largest effect on plasticization and aging). We will measure the CO₂ permeance as a function of pressure at ambient temperature for each material variant (different oligomer and different chain length) for approximately 1000 h (see FIGS. 12 and 14A-14C). The experiments will be done every 3-4 days for each material choice. This will show any plasticization effects for each experiment and if there is any change with time. This will provide an initial assessment of (a) is there an advantage of the IL-based charged polymer membranes compared to conventional uncharged polymers, and (b) which material variant(s) show the best initial improvement compared to neutral polymers (down-selection).

There are several material choices. We will use Matrimid® as the neutral polymer control material. The uncharged oligomer additive will be 10, 20, and 30 units in length. As described above, there will be two different IL polymers. For each IL polymer, there will be two different oligomer additives of 10, 20, and 30 units in length.

### Long-Term Permeation Experiments

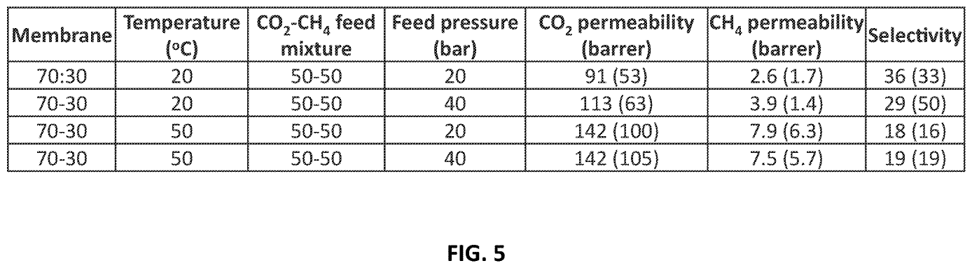

A long-term permeation experiment was conducted to demonstrate the difference between conventional polymer membranes and PIL membranes. The results are shown in FIGS. 16A-16B. The membrane was a 70 wt. % poly([VMIM][Tf₂N])+30 wt. % [EMIM][Tf₂N] blend cross-linked with a novel IL-based cross-linker. For comparison, the variation of relative CO₂ permeability of three different glassy membranes are also shown in FIGS. 16A-16B. All these glassy polymers were tested under milder conditions (Table 3) during the aging studies. In addition, compare this result to the data in FIGS. 5 and 6 under much milder conditions. The use of IL oligomers instead of just IL is anticipated to increase the stability range of these materials.

TABLE 3
Testing conditions and thicknesses for the membranes
and conditions described in FIGS. 16A-16B.

| | Feed | Testing | Membrane | |
|---|---|---|---|---|
| | pressure | temperature | thickness | |
| Membrane | (bar) | (° C.) | (μm) | Reference |
| Cross-linked 70 wt. % | 40 | 50 | 147 | This |
| poly([VMIM][Tf₂N]) + 30 | | | | disclosure |
| wt. % [EMIM][Tf₂N] | | | | |
| membrane | | | | |
| 6FDA-DAM:DABA | 2 | 35 | 0.72 | Ma and |
| (Thin) | | | | Koros, 2018 |
| 6FDA-DAM:DABA | 2 | 35 | 50 | Kratochvil, |
| (Thick) | | | | 2008 |
| Matrimid | 4 | 37 | 55 | Prasetya et |
| | | | | al., 2018 |

### Charged Polymer Blend Membrane Systems Based on PILs to Explore Effects of Charged IL Oligomer Effects on Aging

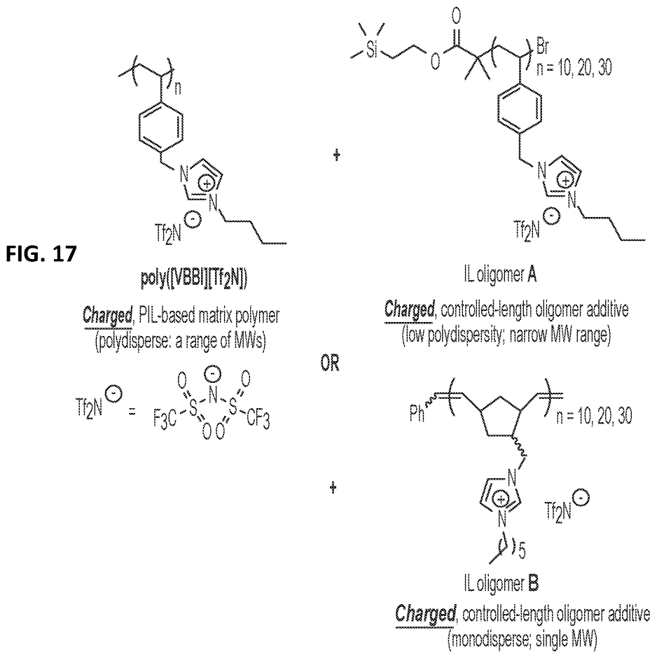

The poly(ionic liquid) (PIL) to be used as the charged matrix polymer for these studies will be poly[1-(p-vinylbenzyl)-3-butylimidazolium bis(trifluoromethyl) sulfonamide] (poly([VBBI][Tf₂N])) (FIG. 17). Poly([VBBI][Tf₂N]) is one of the first PILs synthesized and reported in the literature (Tang et al., 2005). It is a linear, soluble PIL with a range of chain lengths (i.e., polydisperse) that is easily prepared from the radical solution polymerization of the IL monomer, [VBBI][Tf₂N] (Tang et al., 2005). In addition to being well-characterized chemically, poly([VBBI][Tf₂N]) lightly covalently cross-linked with divinylbenzene (DVB) has also been formed into membranes and evaluated for CO₂/light gas separation performance under single-gas testing conditions (Bara et al., 2007).

To determine the effects of blending in charged, controlled-length IL oligomers with poly([VBBI][Tf₂N]), we propose to initially synthesize two different charged IL oligomers of low polydispersity: IL oligomer A and IL oligomer B (FIG. 17). Two IL oligomer platforms are proposed for these blending studies in order to provide variation of additive structure if one IL oligomer system proves problematic in terms of synthesis, compatibility with the PIL matrix, and/or plasticization effects with certain light gases.

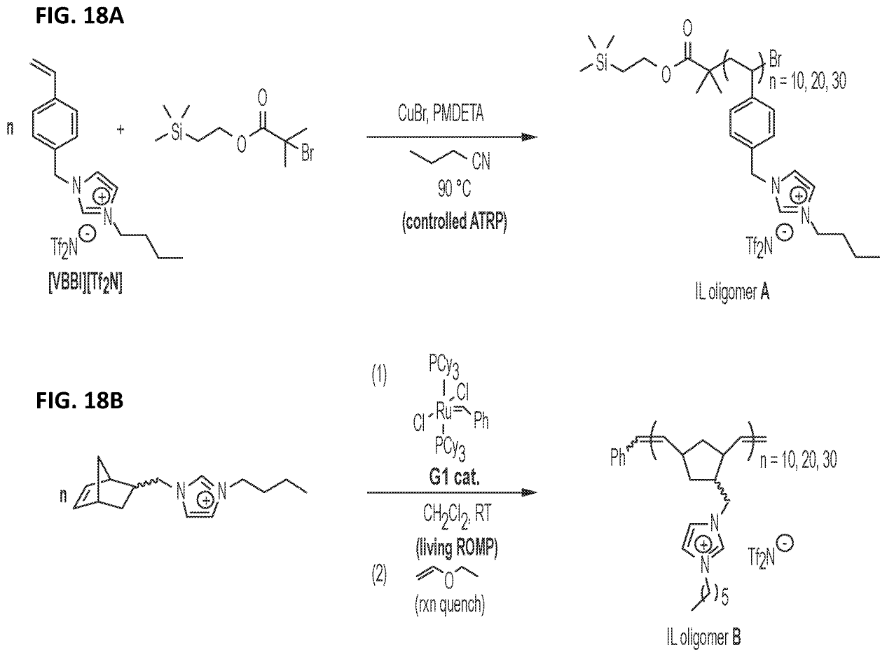

IL oligomer A is structurally similar to poly([VBBI][Tf₂N]) except that it has controlled lengths, chain length uniformity (i.e., low dispersity), and different chain endgroups due to its method of polymerization. Consequently, it will be highly compatible and miscible with the matrix PIL. IL oligomer A will be synthesized by atom-transfer radical polymerization (ATRP) (i.e., a controlled radical chain-addition polymerization method) of the same [VBBI][Tf₂N] IL monomer used to prepare regular poly([VBBI][Tf₂N]) (FIG. 18A). The Gin group has successfully performed ATRP on [VBBI][Tf₂N] to make controlled-length, IL-based homopolymers and block copolymers (Shi et al., 2014). Consequently, short, controlled-length samples of IL oligomer A should be readily accessible. It should also be noted that variants of IL oligomer A (e.g., with different alkyl groups on the imidazolium ring) can be readily prepared via controlled radical polymerization of the corresponding monomers as described in the literature (Shi et al., 2014).

IL oligomer B will have a different polymer backbone and different chain endgroups than poly([VBBI][Tf₂N]) but will be of controlled length and monodisperse in nature. These poly(norbornene)-based homopolymers and block copolymers have previously been synthesized (Wiesenauer et al., 2011 and Wiesenauer et al., 2013) and are soluble in polar organic solvents because of flexible nature of poly(norbornene) backbones. IL oligomer B will be prepared by living ROMP of the appropriate norbornene-based IL monomer, which has been prepared previously by the Gin group (Wiesenauer et al., 2011) (FIG. 18B). The Gin group has previously performed sequential living ROMP on this particular norbornene-based imidazolium Tf₂N-monomer with other norbornene monomers using the first-generation Grubbs olefin-metathesis catalyst (G1) to successfully make controlled-length, IL-based block copolymers (Wiesenauer et al., 2011). Consequently, preparation of controlled-length samples of IL oligomer B via the homopolymerization of just this IL monomer will be even more straight-forward. Variants of IL oligomer B can also be readily prepared via ROMP of slightly different norbornene imidazolium monomers as described in the prior papers from the Gin group (Wiesenauer et al., 2011; Malecha et al., 2020).

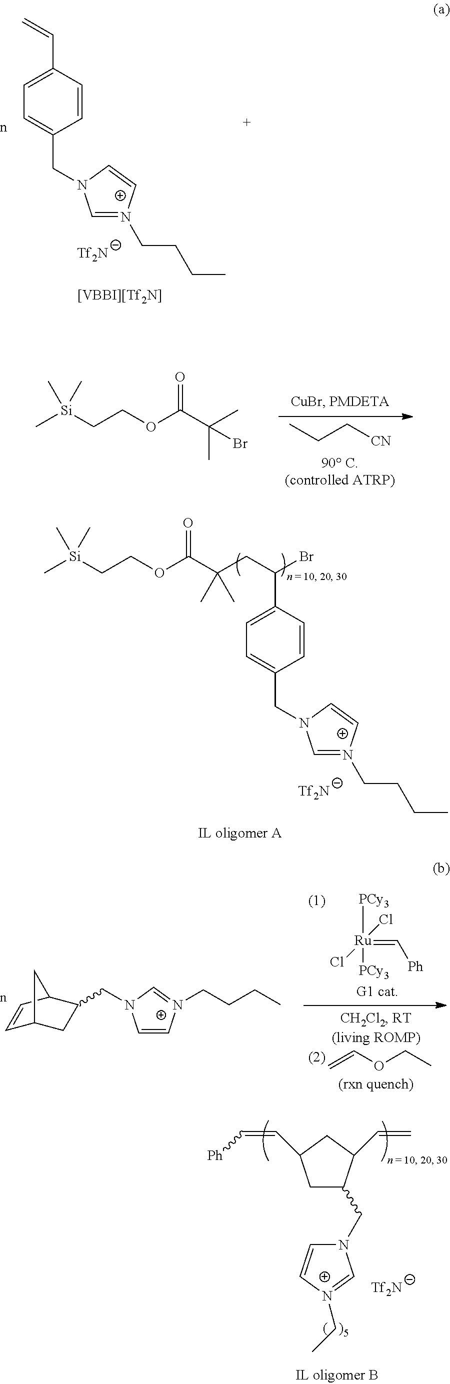

The structures of the chain end-groups on these two IL oligomer platforms are shown in FIGS. 18A-18B because they will be different as a result of the controlled/living polymerization methods employed. The chemistry of the chain endgroups may be important for overall blending compatibility with the PIL matrix polymer since the IL oligomers will be rather short, and the endgroups will make up a substantial fraction of the chain character.

The chemical structures of proposed IL oligomers A and B will be verified by ¹H NMR, ¹³C NMR, and FTIR analyses; and their absolute degree of polymerization will be verified by 1H NMR end-group analysis (Wiesenauer et al., 2011; Shi et al., 2014; Malecha et al., 2020). Physical blends of poly([VBBI][Tf₂N]) with different wt. % values of IL oligomers A or B of different selected chain lengths will be prepared by dissolving the appropriate mass amounts of the materials in a relatively low-boiling organic solvent that is known to dissolve PILs (e.g., acetonitrile), and then removing the solvent by evaporation or in vacuo. As described previously, bulk and TFC membranes for gas permeation aging testing studies will be made by dissolving the blends in a suitable solvent, casting the solution onto a suitable surface (to remove a free-standing bulk film from) or an ultraporous membrane support film (to make a TFC membrane), and removing the solvent by evaporation or in vacuo. The thickness of the bulk membrane or the TFC membrane active layer will be determined by SEM imaging of membrane cross-sections.

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### ENUMERATED EMBODIMENTS

The following enumerated embodiments are provided, the numbering of which is not to be construed as designating levels of importance:

Embodiment 1 provides a composition comprising:
i) a polymerized ionic liquid (PIL) having the formula:

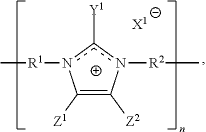

ii) a non-polymerized ionic liquid (IL) having the formula:

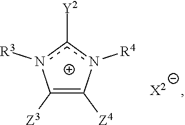

iii) an IL cross-linking agent having a formula selected from the group consisting of:

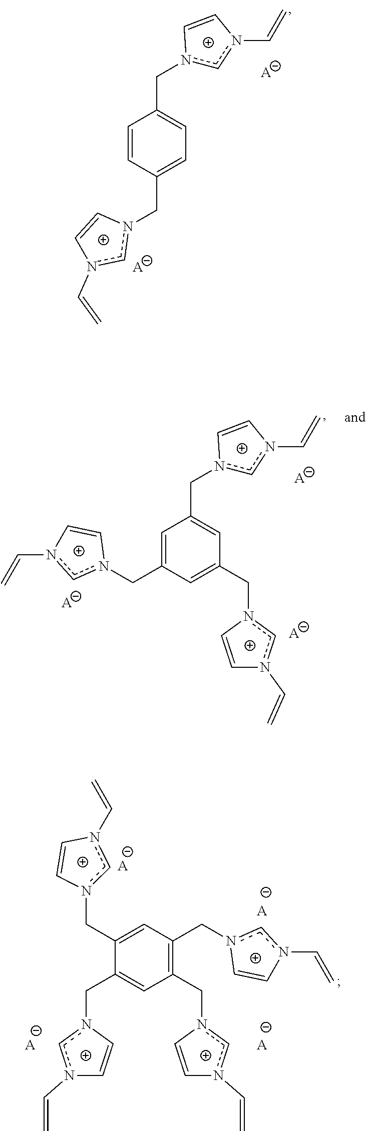

wherein:
   each occurrence of R₁, R₂, R³, and R⁴ is independently selected from the group consisting of C₁₋₂₀ alkyl, C₂₋₂₀ alkenyl, C₂₋₂₀ alkynyl, C₆₋₂₀ aryl, and combinations thereof;
   each occurrence of X¹, X², and A is independently an anion;
   each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
   each occurrence of Z¹, Z², Z³, and Z⁴ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof;
   each occurrence of R is independently hydrogen or C₁₋₆ alkyl;
   n is an integer from 3 to 100,000;
wherein the PIL is cross-linked with the IL cross-linking agent; and
wherein the composition is free of zeolite.

Embodiment 2 provides the composition of embodiment 1, wherein Y¹, Y², Z¹, Z², Z³, and Z⁴ are each independently selected from the group consisting of hydrogen and C₁₋₄ alkyl.

Embodiment 3 the composition of any one of embodiments 1-2, wherein Y¹, Y², Z¹, Z², Z³, and Z⁴ are each hydrogen.

Embodiment 4 provides the composition of any one of embodiments 1-3, wherein R¹ is —CH₂CH₂— and R² is —CH₂—.

Embodiment 5 provides the composition of any one of embodiments 1-4, wherein R³ is methyl and R⁴ is ethyl.

Embodiment 6 provides the composition of any one of embodiments 1-5, wherein X¹, X², and A are each independently selected from the group consisting of F⁻, Cl⁻, Br⁻, BF₄⁻, SbF₆⁻, and Tf₂N⁻.

Embodiment 7 provides the composition of any one of embodiments 1-6, wherein X¹, X², and A are each Tf₂N.

Embodiment 8 provides the composition of any one of embodiments 1-7, wherein the IL is present in an amount of about 1-60 mol % relative to the amount of PIL.

Embodiment 9 provides the composition of any one of embodiments 1-8, wherein the IL is present in an amount of about 10-40 mol % relative to the amount of PIL.

Embodiment 10 provides the composition of any one of embodiments 1-9, wherein the IL cross-linking agent is present in amount of 1 to 25 mol % relative to the total of IL and PIL.

Embodiment 11 provides a membrane comprising a first layer and an opposing second layer,
wherein the first layer comprises a PIL and an IL cross-linking agent, and
wherein a non-polymerized IL is between the first and second layer,
wherein the PIL has the formula:

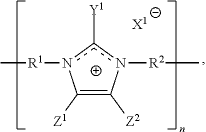

wherein the IL has the formula:

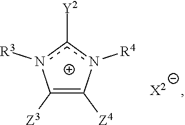

wherein the IL cross-linking agent has the formula selected from the group consisting of:

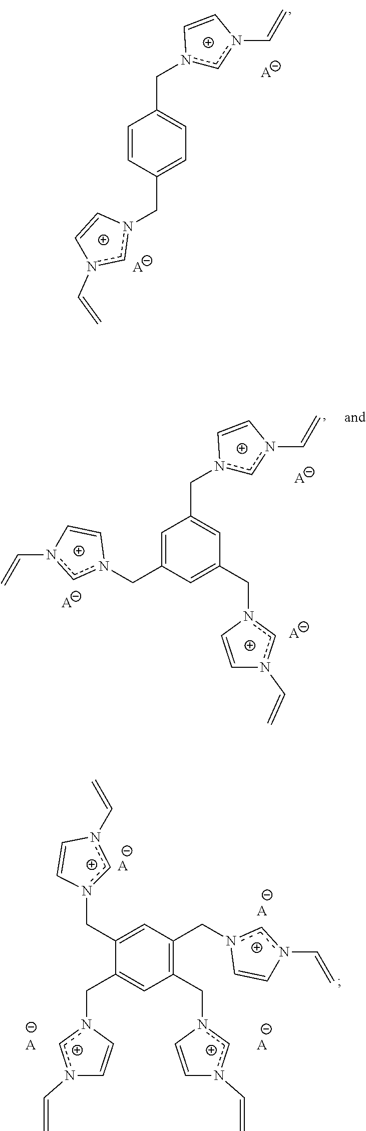

wherein:
each occurrence of R¹, R², R³, and R⁴ is independently selected from the group consisting of C₁₋₂₀ alkyl, C₂₋₂₀ alkenyl, C₂₋₂₀ alkynyl, C₆₋₂₀ aryl, and combinations thereof;
each occurrence of X¹, X², and A is independently an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², Z³, and Z⁴ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof;
each occurrence of R is independently hydrogen or C₁₋₆ alkyl;
n is an integer from 3 to 100,000;
wherein the PIL is cross-linked with the IL cross-linking agent and the composition is free of zeolite.

Embodiment 12 provides the membrane of embodiment 11, wherein the membrane has a CO₂ permeability of at least 50 barrers.

Embodiment 13 provides the membrane of any one of embodiments 11-12, wherein the membrane has a CO₂/CH₄ selectivity of at least 10.

Embodiment 14 provides the membrane of any one of embodiments 11-13, wherein X¹, X², and A are each Tf₂N.

Embodiment 15 provides the membrane of any one of embodiments 11-14, wherein the IL cross-linking agent is present in amount of 1 to 25 mol % relative to the total of IL and PIL.

Embodiment 16 provides the membrane of any one of embodiments 11-15, wherein the second layer comprises the PIL and the IL cross-linking agent.

Embodiment 17 provides the membrane of any one of embodiments 11-16, wherein the second layer is a mechanical support layer.

Embodiment 18 provides the membrane of any one of embodiments 11-17, wherein the first layer is about 0.01 to about 300 μm thick.

Embodiment 19 provides a method for separating a first gas component from a gas mixture containing at least a first gas component and a second gas component, the method comprising the steps of:
a) providing a membrane having a feed and a permeate side and being selectively permeable to the first gas component over the second gas component;
b) applying a feed stream including the first and the second gas components to the feed side of the membrane; and
c) providing a driving force sufficient for permeation of the first gas component through the membrane, thereby producing a permeate stream enriched in the first gas component from the permeate side of the membrane; wherein the membrane comprises:
   i) a polymerized ionic liquid (PIL) having the formula:

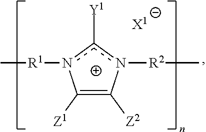

ii) a non-polymerized ionic liquid (IL) having the formula:

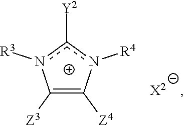

iii) an IL cross-linking agent having the formula selected from the group consisting of:

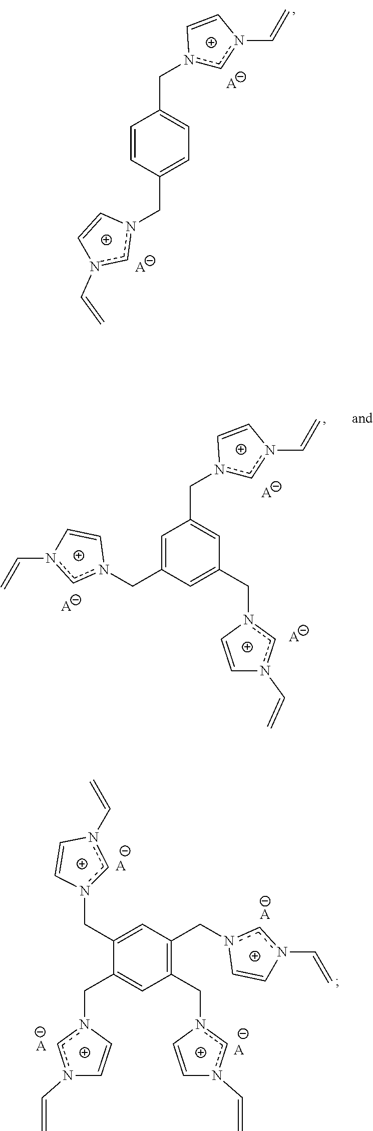

wherein:
each occurrence of R¹, R², R³, and R⁴ is independently selected from the group consisting of C₁₋₂₀ alkyl, C₂₋₂₀ alkenyl, C₂₋₂₀ alkynyl, C₆₋₂₀ aryl, and combinations thereof;
each occurrence of X¹, X², and A is independently an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², Z³, and Z⁴ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof;
each occurrence of R is independently hydrogen or C₁₋₆ alkyl;
n is an integer from 3 to 100,000;
wherein the PIL is cross-linked with the IL cross-linking agent and the composition is free of zeolite.

Embodiment 20 provides the method of embodiment 19, wherein the first gas component is CO₂ and the second gas component is CH₄.

Embodiment 21 provides the method of any one of embodiments 19-20, wherein the first gas component is CO₂ and the second gas component is N₂.

Embodiment 22 provides the method of any one of embodiments 19-21, wherein X¹, X², and A are each Tf₂N⁻.

Embodiment 23 provides the method of any one of embodiments 19-22, wherein the IL cross-linking agent is present in amount of 1 to 25 mol % relative to the total of IL and PIL.

Embodiment 24 provides a polymer of Formula Z, having the structure:

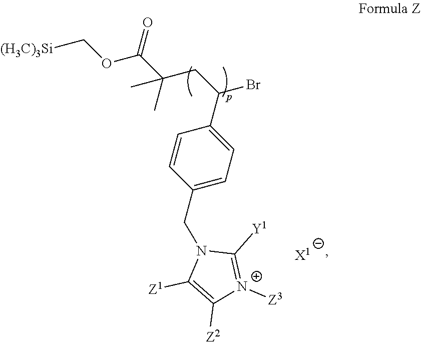

wherein:
   X¹ is an anion;
   each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
   each occurrence of Z¹, Z², and Z³ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof; and
   p is an integer from 1 to 40.

Embodiment 25 provides the polymer of embodiment 24, wherein p is 10, 11, 12, 13, 14, 15, 16, 17, 18, 19, 20, 21, 22, 23, 24, 25, 26, 27, 28, 29, or 30.

Embodiment 26 provides the polymer of any one of embodiments 24-25, wherein Z³ is n-butyl.

Embodiment 27 provides the polymer of any one of embodiments 24-26, wherein X¹ is Tf₂N⁻.

Embodiment 28 provides a polymer of Formula ZZ, having the structure:

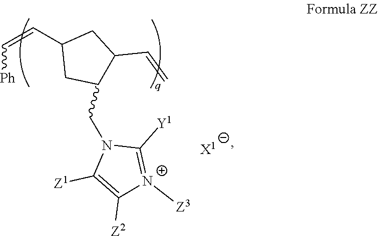

wherein:
   X¹ is an anion;
   each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
   each occurrence of Z¹, Z², and Z³ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof; and
   q is an integer from 1 to 40.

Embodiment 29 provides the polymer of embodiment 28, wherein q is 10, 11, 12, 13, 14, 15, 16, 17, 18, 19, 20, 21, 22, 23, 24, 25, 26, 27, 28, 29, or 30.

Embodiment 30 provides the polymer of any one of embodiments 28-29, wherein Z³ is n-hexyl.

Embodiment 31 provides the polymer of any one of embodiments 28-30, wherein X¹ is Tf₂N⁻.

1. A composition comprising:
i) a polymerized ionic liquid (PIL) having the formula: 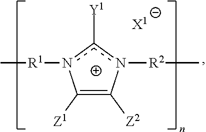
ii) a non-polymerized ionic liquid (IL) having the formula: 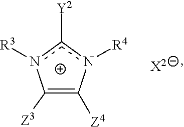
and
iii) an IL cross-linking agent having a formula selected from the group consisting of: 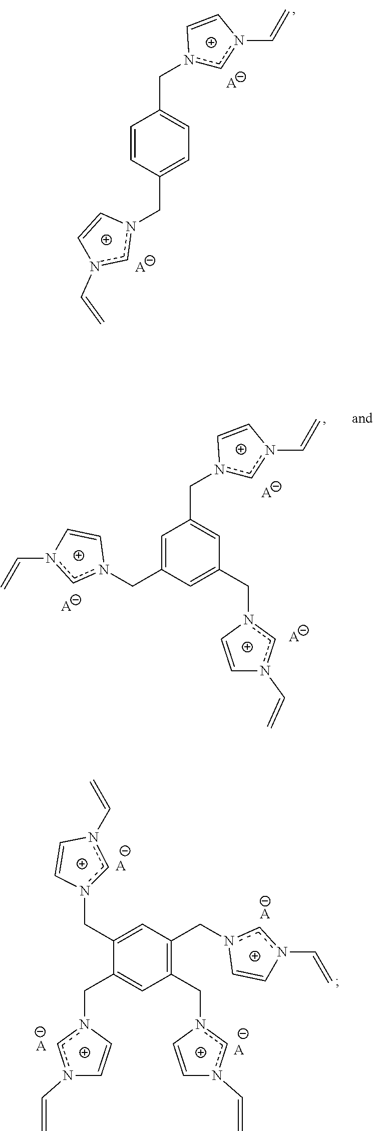
wherein:
each occurrence of R¹, R², R³, and R⁴ is independently selected from the group consisting of C₁₋₂₀ alkyl, C₂₋₂₀ alkenyl, C₂₋₂₀ alkynyl, C₆₋₂₀ aryl, and combinations thereof;
each occurrence of X¹, X², and A is independently an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², Z³, and Z⁴ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof;
each occurrence of R is independently hydrogen or C₁₋₆ alkyl;
n is an integer from 3 to 100,000;
wherein the PIL is cross-linked with the IL cross-linking agent; and
wherein the composition is free of zeolite.

2. The composition of claim 1, wherein Y¹, Y², Z¹, Z², Z³, and Z⁴ are each independently selected from the group consisting of hydrogen and C₁₋₄ alkyl.

3. The composition of claim 2, wherein Y¹, Y², Z¹, Z², Z³, and Z⁴ are each hydrogen.

4. The composition of claim 1, wherein R¹ is —CH₂CH₂— and R² is —CH₂—.

5. The composition of claim 1, wherein R³ is methyl and R⁴ is ethyl.

6. The composition of claim 1, wherein X¹, X², and A are each independently selected from the group consisting of F⁻, Cl⁻, Br⁻, BF₄⁻, SbF₆⁻, and Tf₂N⁻.

7. The composition of claim 1, wherein X¹, X², and A are each Tf₂N⁻.

8. The composition of claim 1, wherein the IL is present in an amount of about 1-60 mol % relative to the amount of PIL.

9. The composition of claim 7, wherein the IL is present in an amount of about 10-40 mol % relative to the amount of PIL.

10. The composition of claim 1, wherein the IL cross-linking agent is present in amount of 1 to 25 mol % relative to the total amount of IL and PIL in the composition.

11. A membrane comprising a first layer and an opposing second layer,
wherein the first layer comprises a PIL and an IL cross-linking agent, and
wherein a non-polymerized IL is between the first and second layer,
wherein the PIL has the formula: 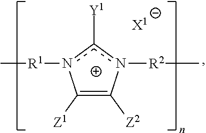
wherein the IL has the formula: 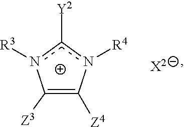
and
wherein the IL cross-linking agent has the formula selected from the group consisting of: 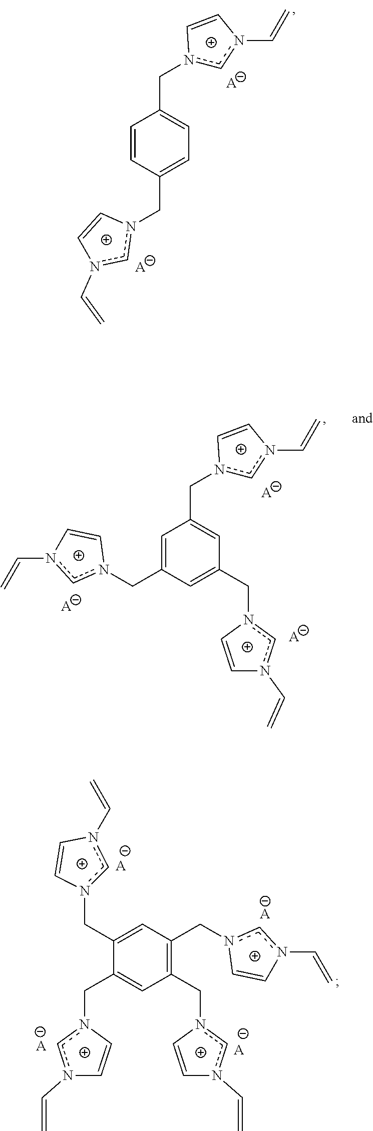
wherein:
each occurrence of R¹, R², R³, and R⁴ is independently selected from the group consisting of C₁₋₂₀ alkyl, C₂₋₂₀ alkenyl, C₂₋₂₀ alkynyl, C₆₋₂₀ aryl, and combinations thereof;
each occurrence of X¹, X², and A is independently an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², Z³, and Z⁴ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof;
each occurrence of R is independently hydrogen or C₁₋₆ alkyl;
n is an integer from 3 to 100,000;
wherein the PIL is cross-linked with the IL cross-linking agent and the membrane is free of zeolite.

12. The membrane of claim 11, wherein the membrane has a CO₂ permeability of at least 50 barrers.

13. The membrane of claim 11, wherein the membrane has a CO₂/CH₄ selectivity of at least 10.

14. The membrane of claim 11, wherein X¹, X², and A are each Tf₂N⁻.

15. The membrane of claim 11, wherein the IL cross-linking agent is present in amount of 1 to 25 mol % relative to the total amount of IL and PIL in the membrane.

16. The membrane of claim 11, wherein the second layer comprises the PIL and the IL cross-linking agent.

17. The membrane of claim 11, wherein the second layer is a mechanical support layer.

18. The membrane of claim 11, wherein the first layer is about 0.01 to about 300 μm thick.

19. A method for separating a first gas component from a gas mixture comprising at least a first gas component and a second gas component, the method comprising the steps of:
a) providing a membrane having a feed and a permeate side and being selectively permeable to the first gas component over the second gas component;
b) applying a feed stream including the first and the second gas components to the feed side of the membrane; and
c) providing a driving force sufficient for permeation of the first gas component through the membrane, thereby producing a permeate stream enriched in the first gas component from the permeate side of the membrane; wherein the membrane comprises:
i) a polymerized ionic liquid (PIL) having the formula: 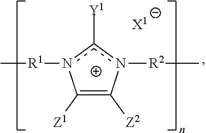
ii) a non-polymerized ionic liquid (IL) having the formula: 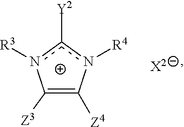
and
iii) an IL cross-linking agent having the formula selected from the group consisting of: 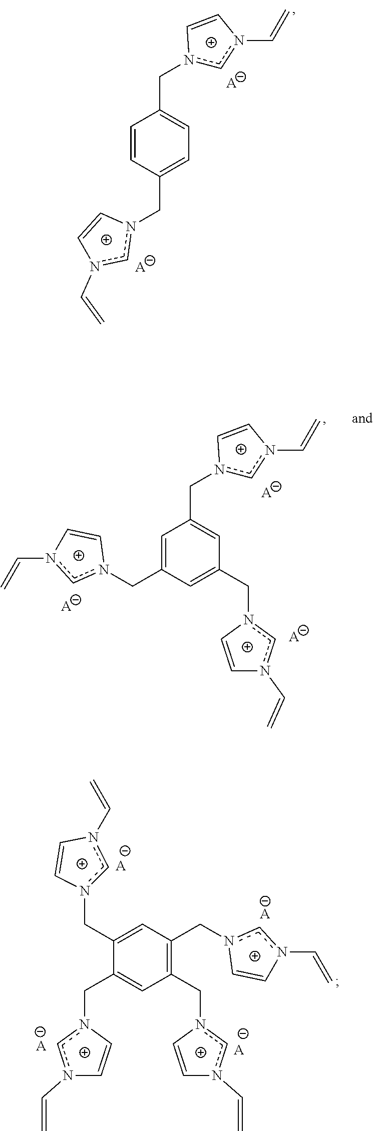
wherein:
each occurrence of R¹, R², R³, and R⁴ is independently selected from the group consisting of C₁₋₂₀ alkyl, C₂₋₂₀ alkenyl, C₂₋₂₀ alkynyl, C₆₋₂₀ aryl, and combinations thereof;
each occurrence of X¹, X², and A is independently an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², Z³, and Z⁴ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof;
each occurrence of R is independently hydrogen or C₁₋₆ alkyl;
n is an integer from 3 to 100,000;
wherein the PIL is cross-linked with the IL cross-linking agent and the membrane is free of zeolite.

20. The method of claim 19, wherein the first gas component is CO₂ and the second gas component is CH₄.

21. The method of claim 19, wherein the first gas component is CO₂ and the second gas component is N₂.

22. The method of claim 19, wherein X¹, X², and A are each Tf₂N⁻.

23. The method of claim 19, wherein the IL cross-linking agent is present in amount of 1 to 25 mol % relative to the total of IL and PIL.

24. A polymer of Formula Z, having the structure: 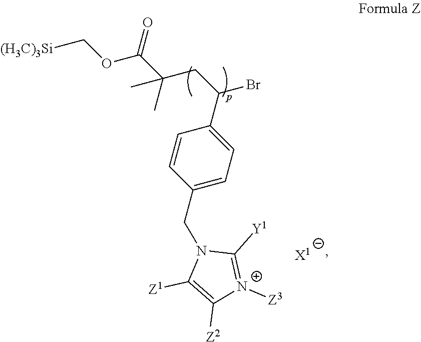
wherein:
X¹ is an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², and Z³ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof; and
p is an integer from 1 to 40.

25. The polymer of claim 24, wherein p is 10, 11, 12, 13, 14, 15, 16, 17, 18, 19, 20, 21, 22, 23, 24, 25, 26, 27, 28, 29, or 30.

26. The polymer of claim 24, wherein Z³ is n-butyl.

27. The polymer of claim 24, wherein X¹ is Tf₂N⁻.

28. A polymer of Formula ZZ, having the structure: 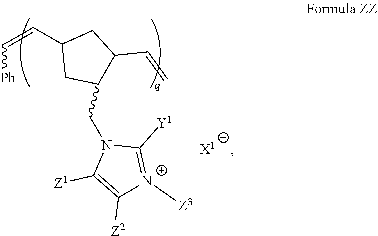
wherein:
X¹ is an anion;
each occurrence of Y¹ and Y² is independently selected from the group consisting of hydrogen, C₁₋₁₂ alkyl, C₂₋₁₂ alkenyl, C₂₋₁₂ alkynyl, C₆₋₁₂ aryl, halogen, OR, CN, NO₂, COOR, and combinations thereof;
each occurrence of Z¹, Z², and Z³ is independently selected from the group consisting of hydrogen, C₁₋₁₂ alkyl, C₂₋₁₂ alkenyl, C₂₋₁₂ alkynyl, C₆₋₁₂ aryl, halogen, CN, OR, NO₂, COOH, and combinations thereof; and
q is an integer from 1 to 40.

29. The polymer of claim 28, wherein q is 10, 11, 12, 13, 14, 15, 16, 17, 18, 19, 20, 21, 22, 23, 24, 25, 26, 27, 28, 29, or 30.

30. The polymer of claim 28, wherein Z³ is n-hexyl.

31. The polymer of claim 28, wherein X¹ is Tf₂N⁻.
